(19) United States
(12) Patent Application Publication
(10) Pub. No.: US 2006/0153537 A1
(43) Pub. Date: Jul. 13, 2006

(54) Data structure of meta data stream on object in moving picture, and search method and playback method therefore

(76) Inventors: Toshimitsu Kaneko, Kawasaki-shi (JP); Toru Kambayashi, Chigasaki-shi (JP); Hiroshi Isozaki, Kawasaki-shi (JP); Yasufumi Tsumagari, Yokohama-shi (JP); Hideki Takahashi, Kashiwa-shi (JP); Yoichiro Yamagata, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/335,537

(22) Filed: Jan. 20, 2006

Related U.S. Application Data
(63) Continuation of application No. PCT/JP05/09714, filed on May 20, 2005.

(30) Foreign Application Priority Data
May 20, 2004 (JP) 2004-150963

(51) Int. Cl. H04N 5/91

(52) U.S. Cl. 386/95; 715/721

(57) ABSTRACT

When the same object appearing in a moving picture is divided into a plurality of items of data (access units), search results using meta data is easily displayed. A meta data stream includes two or more access units AUs having an object_id for specifying whether or not objects designated by object region data in two access units AUs are semantically identical, and an object_subid for specifying whether or not the object region data in the two access units AUs are data on the same scene. From the meta data stream, one of a plurality of access units AUs is selected, the access units being determined to be the same objects by the object_id and being determined to be the same scene by the object_subid, and the selected access unit AU is used to search for an object.

### CROSS-REFERENCE TO RELATED APPLICATIONS

This is a Continuation Application of PCT Application No. PCT/JP2005/009714, filed May 20, 2005, which was published under PCT Article 21(2) in English.

This application is based upon and claims the benefit of priority from prior Japanese Patent Application No. 2004-150963, filed May 20, 2004, the entire contents of which are incorporated herein by reference.

### BACKGROUND OF THE INVENTION

1. Field of the Invention

The present invention relates to a data structure of a meta data stream in a system which combines moving picture data in a client device and meta data in a client device or a server device on the network to realize moving picture hyper media or to display caption or balloon on a moving picture, and a search method and a playback method therefore.

2. Description of the Related Art

Hypermedia define associations called hyperlinks among media such as a moving picture, still picture, audio, text, and the like so as to allow these media to refer to each other or from one to another. For example, text data and still picture data are allocated on a home page which can be browsed using the Internet and is described in HTML, and links are defined all over these text data and still picture data. By designating such link, associated information as a link destination can be immediately displayed. Since the user can access associated information by directly designating a phrase that appeals to him or her, an easy and intuitive operation is allowed.

On the other hand, in hypermedia that mainly include moving picture data in place of text and still picture data, links from objects such as persons, articles, and the like that appear in the moving picture to associated contents such as their text data, still picture data that explain them are defined. When a viewer designates an object, the associated contents are displayed. At this time, in order to define a link between the spatio-temporal region of an object that appears in the moving picture and associated contents, data (object region data) indicating the spatio-temporal region of the object in the moving picture is required.

As the object region data, a mask image sequence having two or more values, arbitrary shape encoding of MPEG-4, a method of describing the loci of feature points of a figure, as described in Jpn. Pat. Appln. KOKAI Publication No. 2000-285253, a method described in Jpn. Pat. Appln. KOKAI Publication No. 2001-111996, and the like may be used. In order to implement hypermedia that mainly include moving picture data, data (action information) that describes an action for displaying other associated contents upon designation of an object is required in addition to the above data. These data other than the moving picture data will be referred to as meta data hereinafter.

As a method of providing moving picture data and meta data to a viewer, a method of preparing a recording medium (video CD, DVD, or the like) that records both moving picture data and meta data is available. In order to provide meta data of moving picture data that has already been owned as a video CD or DVD, only meta data can be downloaded or distributed by streaming from the network. Both moving picture data and meta data may be distributed via the network. At this time, meta data preferably has a format that can efficiently use a buffer, is suited to random access, and is robust against any data loss in the network.

When moving picture data are switched frequently (e.g., when moving picture data captured at a plurality of camera angles are prepared, and a viewer can freely select an arbitrary camera angle; like multi-angle video of DVD video)., meta data must be quickly switched in correspondence with switching of moving picture data (see Jpn. Pat. Appln. KOKAI Publication Nos. 2000-285253, and 2001-111996).

Since meta data on the network associated with a moving picture distributed to an audience includes information on the moving picture or an object which appears in the moving picture, the meta data may be used to search for an object. For example, a name or characteristics of an object which appears allows to search. At this time, it is desired to efficiently search using the meta data.

Further, when such meta data is distributed to an audience in a streaming manner, the meta data is desirably in a form resistant against data loss on the network.

### BRIEF SUMMARY OF THE INVENTION

It is an object of the present invention to provide a data structure of a meta data stream and a search method using the same which enable to efficiently search for an object by using meta data.

It is another object of the present invention to provide a data structure of a meta data stream and a playback method therefor which enable to reduce an influence due to missing parts of meta data, caused by data loss in streaming.

It is a further object of the present invention to provide a data structure of a meta data stream having a reduced data size.

A data structure of a meta data stream according to one aspect of the present invention includes at least two access units which are data units capable of being independently processed. Here, the access unit (for example, Vclick_AU in FIGS. 4, 77 and 78) has first data (for example, object region data 400) where a spatio-temporal region of an object in a moving picture is described, and second data (for example, object_id) which specifies whether or not objects in the moving picture respectively designated by the object region data in at least two different access units are semantically identical. The access unit may include data (for example, 402, B01/B02, C01/02) which specifies a lifetime (or an active time) as information on the lifetime defined for the time axis of the moving picture.

In this manner, the second data (object_id) which specifies the semantically identical objects is described in each access unit so as not to display access units having the same abject ID in the search results in searching.

The access unit may further have third data (for example, object_subid) which specifies whether or not the object region data in at least two access units is data on the same scene in the moving picture when objects in the moving picture respectively designated by the object region data in at least two access units are semantically identical.

In this manner, each access unit has described therein an object_id which specifies the semantically identical objects among the plurality of access units and an object_subid which specifies that each object region data is the data on the same scene so as not to display access units having the same object_id and the same object_subid in the search results in searching.

Further, there may be prepared forth data (for example, a continue flag) which indicates whether or not object regions described in the previous and next access units having the same object_id are temporally continuous to make a determination of a missing access unit or to perform an interpolation processing for an object region.

Furthermore, text data is desirably compressed appropriately to be stored in an access unit, and in this case, the access unit includes data which indicates whether the text data is compressed or non-compressed.

According to the present invention, the object_id is used to omit display of access units having the same object_id, so that many similar search results are not displayed, unlike when a keyword search is performed, thereby facilitating the search for an object.

When the object_id and the object_subid are used together, it is possible to display only objects which appear in different scenes as search results.

A flag which indicates whether or not the object regions described in the previous and next access units having the same object_id are temporally continuous can be used to cope with missing access units.

Compression of the text data makes it possible to reduce the data size of the meta data, thereby enhancing efficiency of transmission/recording.

### BRIEF DESCRIPTION OF THE SEVERAL VIEWS OF THE DRAWING

FIG. 1 is a view for explaining a display example of hypermedia according to an embodiment of the present invention;

FIG. 2 is a block diagram showing an example of the arrangement of a system according to an embodiment of the present invention;

FIG. 3 is a view for explaining the relationship between an object region and object region data according to an embodiment of the present invention;

FIG. 4 is a view for explaining an example of the data structure of an access unit of object meta data according to an embodiment of the present invention;

FIG. 5 is a view for explaining a method of forming a Vclick stream according to an embodiment of the present invention;

FIG. 6 is a view for explaining an example of the configuration of a Vclick access table according to an embodiment of the present invention;

FIG. 7 is a view for explaining an example of the configuration of a transmission packet according to an embodiment of the present invention;

FIG. 8 is a view for explaining another example of the configuration of a transmission packet according to an embodiment of the present invention;

FIG. 9 is a chart for explaining an example of communications between a server and client according to an embodiment of the present invention;

FIG. 10 is a chart for explaining another example of communications between a server and client according to an embodiment of the present invention;

FIG. 11 is a table for explaining an example of data elements of a Vclick stream according to an embodiment of the present invention;

FIG. 12 is a table for explaining an example of data elements of a header of the Vclick stream according to an embodiment of the present invention;

FIG. 13 is a table for explaining an example of data elements of a Vclick access unit (AU) according to an embodiment of the present invention;

FIG. 14 is a table for explaining an example of data elements of a header of the Vclick access unit (AU) according to an embodiment of the present invention;

FIG. 15 is a table for explaining an example of data elements of a time stamp of the Vclick access unit (AU) according to an embodiment of the present invention;

FIG. 16 is a table for explaining an example of data elements of a time stamp skip of the Vclick access unit (AU) according to an embodiment of the present invention;

FIG. 17 is a table for explaining an example of data elements of object attribute information according to an embodiment of the present invention;

FIG. 18 is a table for explaining an example of types of object attribute information according to an embodiment of the present invention;

FIG. 19 is a table for explaining an example of data elements of a name attribute of an object according to an embodiment of the present invention;

FIG. 20 is a table for explaining an example of data elements of an action attribute of an object according to an embodiment of the present invention;

FIG. 21 is a table for explaining an example of data elements of a contour attribute of an object according to an embodiment of the present invention;

FIG. 22 is a table for explaining an example of data elements of a blinking region attribute of an object according to an embodiment of the present invention;

FIG. 23 is a table for explaining an example of data elements of a mosaic region attribute of an object according to an embodiment of the present invention;

FIG. 24 is a table for explaining an example of data elements of a paint region attribute of an object according to an embodiment of the present invention;

FIG. 25 is a table for explaining an example of data elements of text information data of an object according to an embodiment of the present invention;

FIG. 26 is a table for explaining an example of data elements of a text attribute of an object according to an embodiment of the present invention;

FIG. 27 is a table for explaining an example of data elements of a text highlight effect attribute of an object according to an embodiment of the present invention;

FIG. 28 is a table for explaining another example of data elements of a text highlight attribute of an object according to an embodiment of the present invention;

FIG. 29 is a table for explaining an example of data elements of a text blinking effect attribute of an object according to an embodiment of the present invention;

FIG. 30 is a table for explaining an example of data elements of an entry of a text blinking attribute of an object according to an embodiment of the present invention;

FIG. 31 is a table for explaining an example of data elements of a text scroll effect attribute of an object according to an embodiment of the present invention;

FIG. 32 is a table for explaining an example of data elements of a text karaoke effect attribute of an object according to an embodiment of the present invention;

FIG. 33 is a table for explaining another example of data elements of a text karaoke effect attribute of an object according to an embodiment of the present invention;

FIG. 34 is a table for explaining an example of data elements of a layer attribute of an object according to an embodiment of the present invention;

FIG. 35 is a table for explaining an example of data elements of an entry of a layer attribute of an object according to an embodiment of the present invention;

FIG. 36 is a table for explaining an example of data elements of object region data of a Vclick access unit (AU) according to an embodiment of the present invention;

FIG. 37 is a flowchart showing a normal playback start processing sequence (when Vclick data is stored in a server) according to an embodiment of the present invention;

FIG. 38 is a flowchart showing another normal playback start processing sequence (when Vclick data is stored in the server) according to an embodiment of the present invention;

FIG. 39 is a flowchart showing a normal playback end processing sequence (when Vclick data is stored in the server) according to an embodiment of the present invention;

FIG. 40 is a flowchart showing a random access playback start processing sequence (when Vclick data is stored in the server) according to an embodiment of the present invention;

FIG. 41 is a flowchart showing another random access playback start processing sequence (when Vclick data is stored in the server) according to an embodiment of the present invention;

FIG. 42 is a flowchart showing a normal playback start processing sequence (when Vclick data is stored in a client) according to an embodiment of the present invention;

FIG. 43 is a flowchart showing a random access playback start processing sequence (when Vclick data is stored in the client) according to an embodiment of the present invention;

FIG. 44 is a flowchart showing a filtering operation of the client according to an embodiment of the present invention;

FIG. 45 is a flowchart (part 1) showing an access point search sequence in a Vclick stream using a Vclick access table according to an embodiment of the present invention;

FIG. 46 is a flowchart (part 2) showing an access point search sequence in a Vclick stream using a Vclick access table according to an embodiment of the present invention;

FIG. 47 is a view for explaining an example wherein a Vclick_AU effective time interval and active period do not match according to an embodiment of the present invention;

FIG. 48 is a view for explaining an example of the data structure of NULL_AU according to an embodiment of the present invention;

FIG. 49 is a view for explaining an example of the relationship between the Vclick_AU effective time interval and active period using NULL_AU according to an embodiment of the present invention;

FIG. 50 is a flowchart for explaining an example (part 1) of the processing sequence of a meta data manager when NULL_AU according to an embodiment of the present invention is used;

FIG. 51 is a flowchart for explaining an example (part 2) of the processing sequence of a meta data manager when NULL_AU according to an embodiment of the present invention is used;

FIG. 52 is a flowchart for explaining an example (part 3) of the processing sequence of a meta data manager when NULL_AU according to an embodiment of the present invention is used;

FIG. 53 is a view for explaining an example of the structure of an enhanced DVD video disc according to an embodiment of the present invention;

FIG. 54 is a view for explaining an example of the directory structure in the enhanced DVD video disc according to an embodiment of the present invention;

FIG. 55 is a view for explaining an example (part 1) of the structure of Vclick information according to an embodiment of the present invention;

FIG. 56 is a view for explaining an example (part 2) of the structure of Vclick information according to an embodiment of the present invention;

FIG. 57 is a view for explaining an example (part 3) of the structure of Vclick information according to an embodiment of the present invention;

FIG. 58 is a view for explaining a configuration example of Vclick information according to an embodiment of the present invention;

FIG. 59 is a view for explaining description example 1 of Vclick information according to an embodiment of the present invention;

FIG. 60 is a view for explaining description example 2 of Vclick information according to an embodiment of the present invention;

FIG. 61 is a view for explaining description example 3 of Vclick information according to an embodiment of the present invention;

FIG. 62 is a view for explaining description example 4 of Vclick information according to an embodiment of the present invention;

FIG. 63 is a view for explaining description example 5 of Vclick information according to an embodiment of the present invention;

FIG. 64 is a view for explaining description example 6 of Vclick information according to an embodiment of the present invention;

FIG. 65 is a view for explaining description example 7 of Vclick information according to an embodiment of the present invention;

FIG. 66 is a view for explaining another configuration example of Vclick information according to an embodiment of the present invention;

FIG. 67 is a view for explaining an example wherein an English audio Vclick stream is selected by Vclick information according to an embodiment of the present invention;

FIG. 68 is a view for explaining an example wherein a Japanese audio Vclick stream is selected by Vclick information according to an embodiment of the present invention;

FIG. 69 is a view for explaining an example wherein an English caption Vclick stream is selected by Vclick information according to an embodiment of the present invention;

FIG. 70 is a view for explaining an example wherein a Japanese caption Vclick stream is selected by Vclick information according to an embodiment of the present invention;

FIG. 71 is a view for explaining an example wherein an angle 1 Vclick stream is selected by Vclick information according to an embodiment of the present invention;

FIG. 72 is a view for explaining an example wherein an angle 2 Vclick stream is selected by Vclick information according to an embodiment of the present invention;

FIG. 73 is a view for explaining an example wherein a 16:9 (aspect ratio) Vclick stream is selected by Vclick information according to an embodiment of the present invention;

FIG. 74 is a view for explaining an example wherein a 4:3 (aspect ratio) letter box display Vclick stream is selected by Vclick information according to an embodiment of the present invention;

FIG. 75 is a view for explaining an example wherein a 4:3 (aspect ratio) pan scan display Vclick stream is selected by Vclick information according to an embodiment of the present invention;

FIG. 76 is a view for explaining a display example of hypermedia according to an embodiment of the present invention;

FIG. 77 is a view for explaining an example of the data structure of an access unit of object meta data according to an embodiment of the present invention;

FIG. 78 is a view for explaining an example of the data structure of an access unit of object meta data according to an embodiment of the present invention;

FIG. 79 is a view for explaining an example of the data structure of a duration of a Vclick access unit according to an embodiment of the present invention;

FIG. 80 is an explanatory view of a display example of search results of a Vclick access unit according to one embodiment of the invention;

FIG. 81 is an explanatory view of a display example of a search result of the Vclick access unit according to one embodiment of the invention;

FIG. 82 is a flow chart for explaining a flow of a processing of searching the Vclick access unit according to one embodiment of the invention;

FIG. 83 is an explanatory view of a display example of search results of the Vclick access unit according to one embodiment of the invention;

FIG. 84 is a flow chart for explaining a flow of a processing of determining and interpolating a missing Vclick access unit according to one embodiment of the invention;

FIG. 85 is an explanatory view of a method of interpolation the missing Vclick access unit according to one embodiment of the invention;

FIG. 86 is an explanatory view of a data structure of a Vclick access unit header of the Vclick access unit according to one embodiment of the invention;

FIG. 87 is a flow chart for explaining a flow of the processing of determining and interpolating the missing Vclick access unit according to one embodiment of the invention;

FIG. 88 is an explanatory view of a data structure of a name attribute of a Vclick access unit object of the Vclick access unit according to one embodiment of the invention;

FIG. 89 is an explanatory view of a data structure of an action attribute of the Vclick access unit object of the Vclick access unit according to one embodiment of the invention; and

FIG. 90 is an explanatory view of a data structure of text information of the Vclick access unit object of the Vclick access unit according to one embodiment of the invention.

### DETAILED DESCRIPTION OF THE INVENTION

An embodiment of the present invention will be described hereinafter with reference to the accompanying drawings.

(Overview of Application)

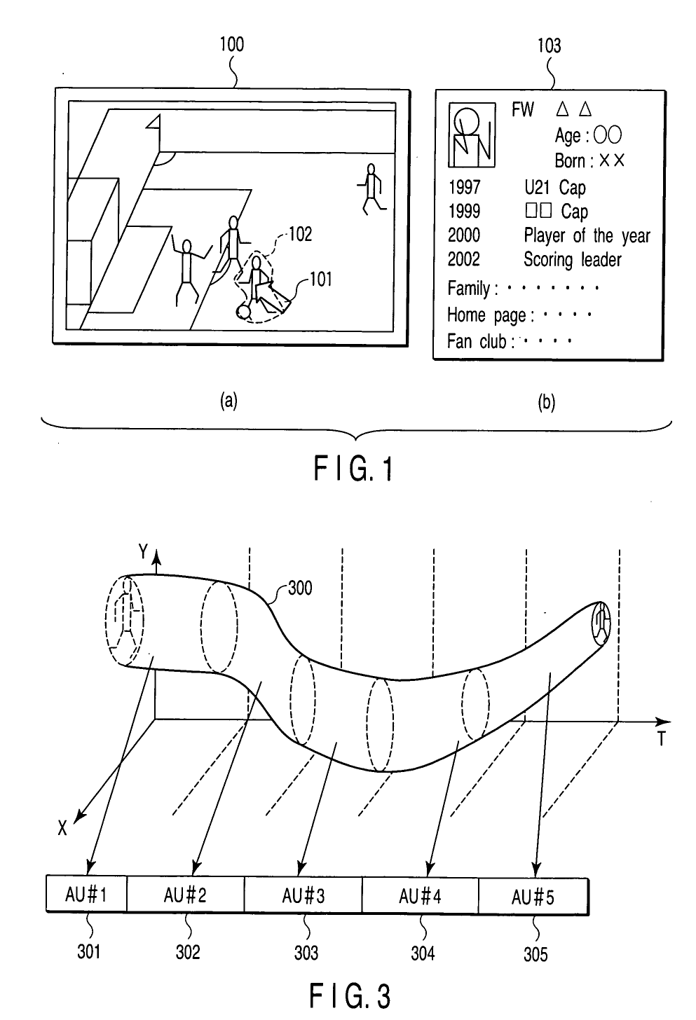

FIG. 1 is a display example of an application (moving picture hypermedia) implemented by using object meta data according to the present invention together with a moving picture on the screen. In FIG. 1(a), reference numeral 100 denotes a moving picture playback window; and 101, a mouse cursor. Data of the moving picture which is played back on the moving picture playback window is recorded on a local moving picture data recording medium. Reference numeral 102 denotes a region of an object that appears in the moving picture. When the user moves the mouse cursor into the region of the object and selects it by, e.g., clicking a mouse button, a predetermined function is executed. For example, in FIG. 1(b), document (information associated with the clicked object) 103 on a local disc and/or a network is displayed. In addition, a function of jumping to another scene of the moving picture, a function of playing back another moving picture file, a function of changing a playback mode, and the like can be executed.

Data of region 102 of the object, action data of a client upon designation of this region by, e.g., clicking or the like, and the like will be referred to as object meta data or Vclick data together. The object meta data may be recorded on a local moving picture data recording medium (optical disc, hard disc, semiconductor memory, or the like) together with moving picture data, or may be stored in a server on the network and may be sent to the client via the network. How to express this application will be described in detail hereinafter.

(System Model)

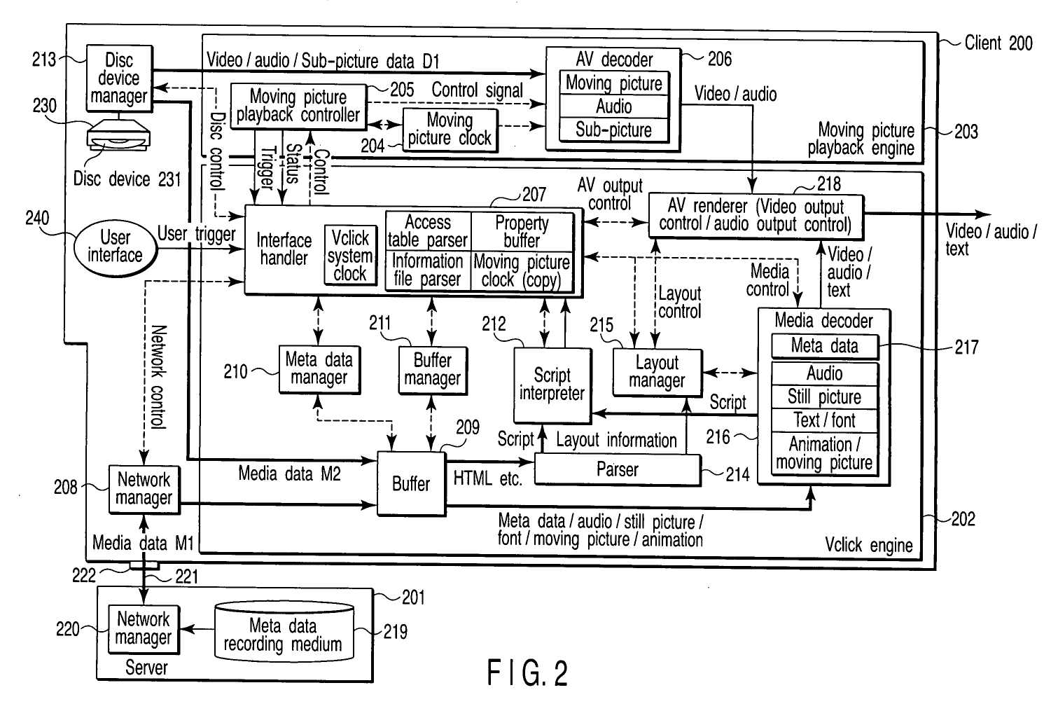

FIG. 2 is a schematic block diagram showing the arrangement of a streaming apparatus (network compatible disc player) according to an embodiment of the present invention. The functions of respective building components will be described below using FIG. 2.

Reference numeral 200 denotes a client; 201, a server; and 221, a network that connects the server and client. Client 200 comprises moving picture playback engine 203, Vclick engine 202, disc device 230, user interface 240, network manager 208, and disc device manager 213. Reference numerals 204 to 206 denote devices included in the moving picture playback engine; 207, 209 to 212, and 214 to 218, devices included in the Vclick engine; and 219 and 220, devices included in the server. Client 200 can play back moving picture data, and can display a document described in a markup language (e.g., HTML or the like), which are stored in disc device 230. Also, client 200 can display a document (e.g., HTML) on the network.

When meta data associated with moving picture data stored in client 200 is stored in server 201, client 200 can execute a playback process using this meta data and the moving picture data in disc device 230. Server 201 sends media data M1 to client 200 via network 221 in response to a request from client 200. Client 200 processes the received media data in synchronism with playback of a moving picture to implement additional functions of hypermedia and the like (note that “synchronization” is not limited to a physically perfect match of timings but some timing error is allowed).

Moving picture playback engine 203 is used to play back moving picture data stored in disc device 230, and has devices 204, 205, and 206. Reference numeral 231 denotes a moving picture data recording medium (more specifically, a DVD, video CD, video tape, hard disc, semiconductor memory, or the like). Moving picture data recording medium 231 records digital and/or analog moving picture data. Meta data associated with moving picture data may be recorded on moving picture data recording medium 231 together with the moving picture data. Reference numeral 205 denotes a moving picture playback controller, which can control playback of video/audio/sub-picture data D1 from moving picture data recording medium 231 in accordance with a “control signal” output from interface handler 207 of Vclick engine 202.

More specifically, moving picture playback controller 205 can output a “trigger” signal indicating the playback status of video/audio/sub-picture data D1 to interface handler 207 in accordance with a “control” signal which is generated upon generation of an arbitrary event (e.g., a menu call or title jump based on a user instruction) from interface handler 207 in a moving picture playback mode. In this case (at a timing simultaneously with output of the trigger signal or an appropriate timing before or after that timing), moving picture playback controller 205 can output a “status” signal indicating property information (e.g., an audio language, sub-picture caption language, playback operation, playback position, various kinds of time information, disc contents, and the like set in the player) to interface handler 207. By exchanging these signals, a moving picture read process can be started or stopped, and access to a desired location in moving picture data can be made.

AV decoder 206 has a function of decoding video data, audio data, and sub-picture data recorded on moving picture data recording medium 231, and outputting decoded video data (mixed data of the aforementioned video and sub-picture data) and audio data. Moving picture playback engine 203 can have the same functions as those of a playback engine of a normal DVD video player which is manufactured on the basis of the existing DVD video standard. That is, client 200 in FIG. 2 can play back video data, audio data, and the like with the MPEG2 program stream structure in the same manner as a normal DVD video player, thus allowing playback of existing DVD video discs (discs complying with the conventional DVD video standard) (to assure playback compatibility with existing DVD software).

Interface handler 207 makes interface control among modules such as moving picture playback engine 203, disc device manager 213, network manager 208, meta data manager 210, buffer manager 211, script interpreter 212, media decoder 216 (including meta data decoder 217), layout manager 215, AV renderer 218, and the like. Also, interface handler 207 receives an input event by a user operation (operation to an input device such as a mouse, touch panel, keyboard, or the like) and transmits an event to an appropriate module.

Interface handler 207 has an access table parser that parses a Vclick access table (to be described later), an information file parser that parses a Vclick information file (to be described later), a property buffer that records property information managed by the Vclick engine, a system clock of the Vclick engine, a moving picture clock as a copy of moving picture clock 204 in the moving picture playback engine, and the like.

Network manager 208 has a function of acquiring a document (e.g., HTML), still picture data, audio data, and the like onto buffer 209 via the network, and controls the operation of Internet connection unit 222. When network manager 208 receives a connection/disconnection instruction to/from the network from interface handler 207 that has received a user operation or a request from meta data manager 210, it switches connection/disconnection of Internet connection unit 222. Upon establishing connection between server 201 and Internet connection unit 222 via the network, network manager 208 exchanges control data and media data (object meta data).

Data to be transmitted from client 200 to server 201 include a session open request, session close request, media data (object meta data) transmission request, status information (OK, error, etc.), and the like. Also, status information of the client may be exchanged. On the other hand, data to be transmitted from the server to the client include media data (object meta data) and status information (OK, error, etc.)

Disc device manager 213 has a function of acquiring a document (e.g., HTML), still picture data, audio data, and the like onto buffer 209, and a function of transmitting video/audio/sub-picture data D1 to moving picture playback engine 203. Disc device manager 213 executes a data transmission process in accordance with an instruction from meta data manager 210.

Buffer 209 temporarily stores media data M1 which is sent from server 201 via the network (via the network manager). Moving picture data recording medium 231 records media data M2 in some cases. In such case, media data M2 is stored in buffer 209 via the disc device manager. Note that media data includes Vclick data (object meta data), a document (e.g., HTML), and still picture data, moving picture data, and the like attached to the document.

When media data M2 is recorded on moving picture data recording medium 231, it may be read out from moving picture data recording medium 231 and stored in buffer 209 in advance prior to the start of playback of video/audio/sub-picture data D1. This is for the following reason: since media data M2 and video/audio/sub-picture data D1 have different data recording locations on moving picture data recording medium 231, if normal playback is made, a disc seek or the like occurs and seamless playback cannot be guaranteed. The above process can avoid such problem.

As described above, when media data M1 downloaded from server 201 is stored in buffer 209 as in media data M2 recorded on moving picture data recording medium 231, video/audio/sub-picture data D1 and media data can be simultaneously read out and played back.

Note that the storage capacity of buffer 209 is limited. That is, the data size of media data M1 or M2 that can be stored in buffer 209 is limited. For this reason, unnecessary data may be erased under the control (buffer control) of metal data manager 210 and/or buffer manager 211.

Meta data manager 210 manages meta data stored in buffer 209, and transfers meta data having a corresponding time stamp to media decoder 216 upon reception of an appropriate timing (“moving picture clock” signal) synchronized with playback of a moving picture from interface handler 207.

When meta data having a corresponding time stamp is not present in buffer 209, it need not be transferred to media decoder 216. Meta data manager 210 controls to load data for a size of the meta data output from buffer 209 or for an arbitrary size from server 201 or disc device 230 onto buffer 209. As a practical process, meta data manager 210 issues a meta data acquisition request for a designated size to network manager 208 or disc device manager 213 via interface handler 207. Network manager 208 or disc device manager 213 loads meta data for the designated size onto buffer 209, and sends a meta data acquisition completion response to meta data manager 210 via interface handler 207.

Buffer manager 211 manages data (a document (e.g., HTML), still picture data and moving picture data appended to the document, and the like) other than meta data stored in buffer 209, and sends data other than meta data stored in buffer 209 to parser 214 and media decoder 216 upon reception of an appropriate timing (“moving picture clock” signal) synchronized with playback of a moving picture from interface handler 207. Buffer manager 211 may delete data that becomes unnecessary from buffer 209.

Parser 214 parses a document written in a markup language (e.g., HTML), and sends a script to script interpreter 212 and information associated with a layout to layout manager 215.

Script interpreter 212 interprets and executes a script input from parser 214. Upon executing the script, information of an event and property input from interface handler 207 can be used. When an object in a moving picture is designated by the user, a script is input from meta data decoder 217 to script interpreter 212.

AV renderer 218 has a function of controlling video/audio/text outputs. More specifically, AV renderer 218 controls, e.g., the video/text display positions and display sizes (often also including the display timing and display time together with them) and the level of audio (often also including the output timing and output time together with it) in accordance with a “layout control” signal output from layout manager 215, and executes pixel conversion of a video in accordance with the type of a designated monitor and/or the type of a video to be displayed. The video/audio/text outputs to be controlled are those from moving picture playback engine 203 and media decoder 216. Furthermore, AV renderer 218 has a function of controlling mixing or switching of video/audio data input from moving picture playback engine 203 and video/audio/text data input from the media decoder in accordance with an “AV output control” signal output from interface handler 207.

Layout manager 215 outputs a “layout control” signal to AV renderer 218. The “layout control” signal includes information associated with the sizes and positions of moving picture/still picture/text data to be output (often also including information associated with the display times such as display start/end timings and duration), and is used to designate AV renderer 218 about a layout used to display data. Layout manager 215 checks input information such as user's clicking or the like input from interface handler 207 to determine a designated object, and instructs meta data decoder 217 to extract an action command such as display of associated information which is defined for the designated object. The extracted action command is sent to and executed by script interpreter 212.

Media decoder 216 (including meta data decoder) decodes moving picture/still picture/text data. These decoded video data and text image data are transmitted from media decoder 216 to AV renderer 218. These data to be decoded are decoded in accordance with an instruction of a “media control” signal from interface handler 207 and in synchronism with a “timing” signal from interface handler 207.

Reference numeral 219 denotes a meta data recording medium of the server such as a hard disc, semiconductor memory, magnetic tape, or the like, which records meta data to be transmitted to client 200. This meta data is associated with moving picture data recorded on moving picture data recording medium 231. This meta data includes object meta data to be described later. Reference numeral 220 denotes a network manager of the server, which exchanges data with client 200 via network 221.

(EDVD Data Structure and IFO File)

FIG. 53 shows an example of the data structure when an enhanced DVD video disc is used as moving picture data recording medium 231. A DVD video area of the enhanced DVD video disc stores DVD video contents (having the MPEG2 program stream structure) having the same data structure as the DVD video standard. Furthermore, another recording area of the enhanced DVD video disc stores enhanced navigation (to be abbreviated as ENAV) contents which allow various playback processes of video contents. Note that the recording area is also recognized by the DVD video standard.

A basic data structure of the DVD video disc will be described below. The recording area of the DVD video disc includes a lead-in area, volume space, and lead-out area in turn from its inner periphery. The volume space includes a volume/file structure information area and DVD video area (DVD-Video zone), and can also have another recording area (DVD other zone) as an option.

Volume/file structure information area 2 is assigned for the UDF (Universal Disk Format) bridge structure. The volume of the UDF bridge format is recognized according to ISO/IEC13346 Part 2. A space that recognizes this volume includes successive sectors, and starts from the first logical sector of the volume space in FIG. 53. First 16 logical sectors are reserved for system use specified by IS09660. In order to assure compatibility to the conventional DVD video standard, the volume/file structure information area with such contents is required.

The DVD video area records management information called video manager VMG and one or more video contents called video title sets VTS (VTS#1 to VTS#n). The VMG is management information for all VTSs present in the DVD video area, and includes control data VMGI, VMG menu data VMGM_VOBS (option), and VMG backup data. Each VTS includes control data VTSI of that VTS, VTS menu data VTSM_VOBS (option), data VTSTT_VOBS of the contents (movie or the like) of that VTS (title), and VTSI backup data. To assure compatibility to the conventional DVD video standard, the DVD video area with such contents is also required.

A playback select menu or the like of each title (VTS#1 to VTS#n) is given in advance by a provider (the producer of a DVD video disc) using the VMG, and a playback chapter select menu, the playback order of recorded contents (cells), and the like in a specific title (e.g., VTS#1) are given in advance by the provider using the VTSI. Therefore, the viewer of the disc (the user of the DVD video player) can enjoy the recorded contents of that disc in accordance with menus of the VMG/VTSI prepared in advance by the provider and playback control information (program chain information PGCI) in the VTSI. However, with the DVD video standard, the viewer (user) cannot play back the contents (movie or music) of each VTS by a method different from the VMG/VTSI prepared by the provider.

The enhanced DVD video disc shown in FIG. 53 is prepared for a scheme that allows the user to play back the contents (movie or music) of each VTS by a method different from the VMG/VTSI prepared by the provider, and to play back while adding contents different from the VMG/VTSI prepared by the provider. ENAV contents included in this disc cannot be accessed by a DVD video player which is manufactured on the basis of the conventional DVD video standard (even if the ENAV contents can be accessed, their contents cannot be used). However, a DVD video player according to an embodiment of the present invention can access the ENAV contents, and can use their playback contents.

The ENAV contents include data such as audio data, still picture data, font/text data, moving picture data, animation data, Vclick data, and the like, and also an ENAV document (described in a Markup/Script language) as information for controlling playback of these data. This playback control information describes, using a Markup language or Script language, playback methods (display method, playback order, playback switch sequence, selection of data to be played back, and the like) of the ENAV contents (including audio, still picture, font/text, moving picture, animation, Vclick, and the like) and/or the DVD video contents. For example, Markup languages such as HTML (Hyper Text Markup Language)/XHTML (extensible Hyper Text Markup Language), SMIL (Synchronized Multimedia Integration Language), and the like, Script languages such as an ECMA (European Computer Manufacturers Association) script, JavaScript, and the like, and so forth, may be used in combination.

Since the contents of the enhanced DVD video disc in FIG. 53 except for the other recording area comply with the DVD video standard, video contents recorded on the DVD video area can be played back using an already prevalent DVD video player (i.e., this disc is compatible to the conventional DVD video disc).

The ENAV contents recorded on the other recording area cannot be played back (or used) by the conventional DVD video player but can be played back and used by a DVD video player according to an embodiment of the present invention. Therefore, when the ENAV contents are played back using the DVD video player according to the embodiment of the present invention, the user can enjoy not only the contents of the VMG/VTSI prepared in advance by the provider but also a variety of video playback features.

Especially, as shown in FIG. 53, the ENAV contents include Vclick data, which includes a Vclick information file (Vclick Info), Vclick access table, Vclick stream, Vclick information file backup (Vclick Info backup), and Vclick access table backup.

The Vclick information file is data indicating a portion of DVD video contents where a Vclick stream (to be described below) is appended (e.g., to the entire title, the entire chapter, a part thereof, or the like of the DVD video contents). The Vclick access table is assured for each Vclick stream (to be described below), and is used to access the Vclick stream. The Vclick stream includes data such as location information of an object in a moving picture, an action description to be made upon clicking the object, and the like. The Vclick information file backup is a backup of the aforementioned Vclick information file, and always has the same contents as the Vclick information file. The Vclick access table backup is a backup of the Vclick access table, and always has the same contents as Vclick access table. In the example of FIG. 53, Vclick data is recorded on the enhanced DVD video disc. However, as described above, Vclick data is stored in a server on the network in some cases.

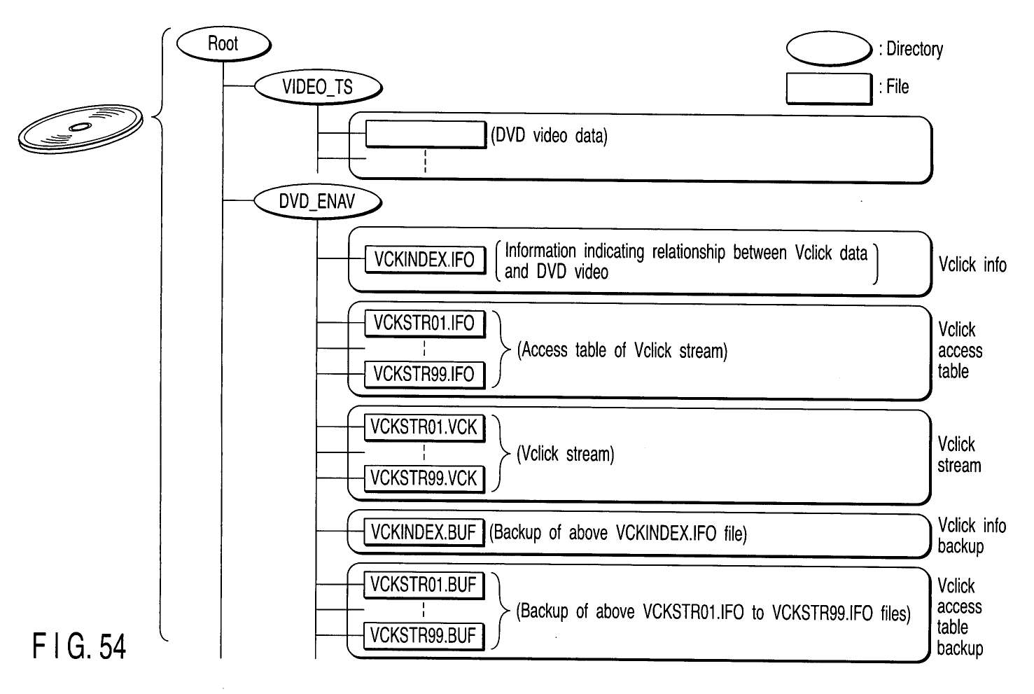

FIG. 54 shows an example of files which form the aforementioned Vclick information file, Vclick access table, Vclick stream, Vclick information file backup, and Vclick access table backup. A file (VCKINDEX.IFO) that forms the Vclick information file is described in XML (extensible Markup Language), and describes a Vclick stream and the location information (VTS number, title number, PGC number, or the like) of the DVD video contents where the Vclick stream is appended. The Vclick access table is made up of one or more files (VCKSTR01.IFO to VCKSTR99.IFO or arbitrary file names), and one access table file corresponds to one Vclick stream.

A Vclick stream file describes the relationship between location information (a relative byte size from the head of the file) of each Vclick stream and time information (a time stamp of a corresponding moving picture or relative time information from the head of the file), and allows to search for a playback start position corresponding to a given time.

The Vclick stream includes one or more files (VCKSTR01.VCK to VCKSTR99.VCK or arbitrary file names), and can be played back together with the appended DVD video contents with reference to the description of the aforementioned Vclick information file. If there are a plurality of attributes (e.g., Japanese Vclick data, English Vclick data, and the like), different Vclick streams, i.e., different files may be formed in correspondence with different attributes, or respective attributes may be multiplexed to form one Vclick stream, i.e., one file. In case of the former configuration (a plurality of Vclick streams are formed in correspondence with different attributes), the buffer occupied size upon temporarily storing Vclick data in the playback apparatus (player) can be reduced. In case of the latter configuration (one Vclick file is formed to include different attributes), one file can be kept played back without switching files upon switching attributes, thus assuring high switching speed.

Note that each Vclick stream and Vclick access table can be associated using, e.g., their file names. In the aforementioned example, one Vclick access table (VCKSTRXX.IFO; XX=01 to 99) is assigned to one Vclick stream (VCKSTRXX.VCK; XX=01 to 99). Hence, by adopting the same file name except for extensions, association between the Vclick stream and Vclick access table can be identified.

In addition, the Vclick information file describes association between each Vclick stream and Vclick access table (describes them parallelly), thereby identifying association between the Vclick stream and Vclick access table.

The Vclick information file backup is formed of a VCKINDEX.BUP file, and has the same contents as the aforementioned Vclick information file (VCKINDEX.IFO). If VCKINDEX.IFO cannot be loaded for some reason (due to scratches, stains, and the like on the disc), desired procedures can be made by loading this VCKINDEX.BUP instead. The Vclick access table backup is formed of VCKSTR01.BUP to VCKSTR99.BUP files, which have the same contents as the aforementioned Vclick access table (VCKSTR01.IFO to VCKSTR99.IFO). One Vclick access table backup (VCKSTRXX.BUP; XX=01 to 99) is assigned to one Vclick access table (VCKSTRXX.IFO; XX=01 to 99), and the same file name is adopted except for extensions, thus identifying association between the Vclick access table and Vclick access table backup. If VCKSTRXX.IFO cannot be loaded for some reason (due to scratches, stains, and the like on the disc), desired procedures can be made by loading this VCKSTRXX.BUP instead.

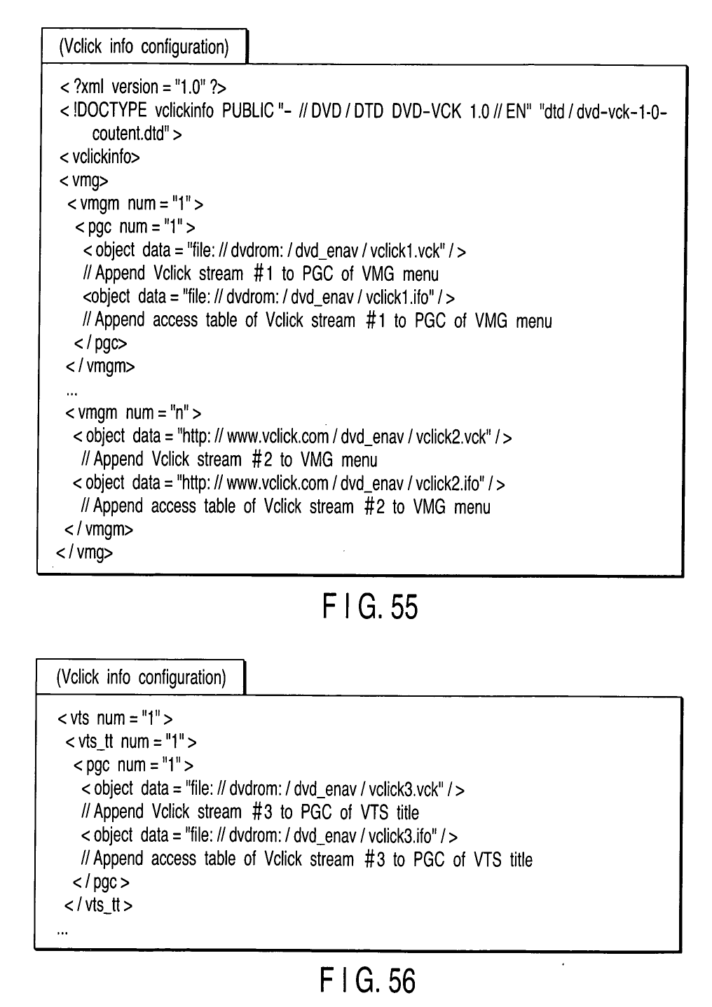

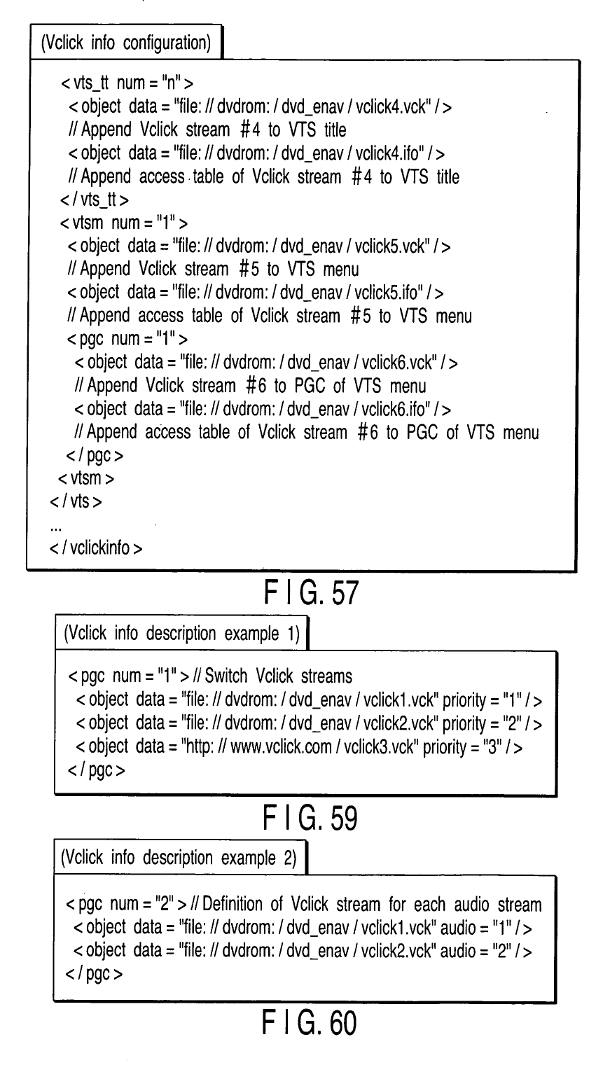

FIGS. 55 to 57 show an example of the configuration of the Vclick information file. The Vclick information file is made up of XML, use of XML is declared first, and a Vclick information file made up of XML is declared next. Furthermore, the contents of the Vclick information file are described using a <vclickinfo> tag.

The <vclickinfo> field includes zero or one <vmg> tag and zero or one or more <vts> tags. The <vmg> field represents a VMG space in DVD video, and indicates that a Vclick stream described in the <vmg> field is appended to DVD video data in the VMG space. Also, the <vts> field represents a VTS space in DVD video, and designates the number of a VTS space by appending a num attribute in the <vts> tag. For example, <vts num=“n”> represents the n-th VTS space. It indicates that a Vclick stream described in the <vts num=“n”> field is appended to DVD video data which forms the n-th VTS space.

The <vmg> field includes zero or one or more <vmgm> tags. The <vmgm> field represents a VMG menu domain in the VMG space, and designates the number of a VMG menu domain by appending a num attribute in the <vmgm> tag. For example, <vmgm num=“n”> indicates the n-th VMG menu domain. It indicates that a Vclick stream described in the <vmgm num=“n”> field is appended to DVD video data which forms the n-th VMG menu domain.

Furthermore, the <vmgm> field includes zero or one or more <pgc> tags. The <pgc> field represents a PGC (Program Chain) in the VMG menu domain, and designates the number of a PGC by appending a num attribute in the <pgc> tag. For example, <pgc num=“n”> indicates the n-th PGC. It indicates that a Vclick stream described in the <pgc num=“n”> field is appended to DVD video data which forms the n-th PGC.

Next, the <vts> field includes zero or one or more <vts_tt> tags and zero or one or more <vtsm> tags. The <vts_tt> field represents a title domain in the VTS space, and designates the number of a title domain by appending a num attribute in the <vts_tt> tag. For example, <vts_tt num=“n”> indicates the n-th title domain. It indicates that a Vclick stream described in the <vts_tt num=“n”> field is appended to DVD video data which forms the n-th title domain.

The <vtsm> field represents a VTS menu domain in the VTS space, and designates the number of a VTS menu domain by appending a num attribute in the <vtsm> tag. For example, <vtsm num=“n”> indicates the n-th title domain. It indicates that a Vclick stream described in the <vtsm num=“n”> field is appended to DVD video data which forms the n-th VTS menu domain.

Moreover, the <vts_tt> or <vtsm> field includes zero or one or more <pgc> tags. The <pgc> field represents a PGC (Program Chain) in the title or VTS menu domain, and designates the number of a PGC by appending a num attribute in the <pgc> tag. For example, <pgc num=“n”> indicates the n-th PGC. It indicates that a Vclick stream described in the <pgc num=“n”> field is appended to DVD video data which forms the n-th PGC.

In the example shown in FIGS. 55 to 57, six Vclick streams are appended to the DVD video contents. For example, the first Vclick stream is designated using an <object> tag in <pgc num=“1”> in <vmgm num=“1”> in <vmg>. This indicates that the Vclick stream designated by the <object> tag is appended to the first PGC in the first VMG menu domain in the VMG space.

The <object> tag indicates the location of the Vclick stream using a “data” attribute. For example, in the embodiment of the present invention, the location of the Vclick stream is designated by “file://dvdrom:/dvd_enav/vclick1.vck”. Note that “file://dvdrom:/” indicates that the Vclick stream is present in the enhanced DVD disc, “dvd_enav/” indicates that the stream is present under a “DVD_ENAV” directory in the disc, and “vclick1.vck” indicates the file name of the Vclick stream. By including the <object> tag which describes the Vclick stream and that which describes a Vclick access table, information of the Vclick access table corresponding to the Vclick stream can be described. In the <object> tag, the location of the Vclick access table is indicated using a “data” attribute. For example, in the embodiment of the present invention, the location of the Vclick access table is designated by “file://dvdrom:/dvd_enav/vclick1.ifo”. Note that “file://dvdrom:/” indicates that the Vclick access table is present in the enhanced DVD disc, “dvd_enav/” indicates that the table is present under a “DVD_ENAV” directory in the disc, and “vclick1.ifo” indicates the file name of the Vclick access table.

The next Vclick stream is designated using an <object> tag in <vmgm num=“n”> in <vmg>.

This indicates that a Vclick stream designated by the <object> tag is appended to the whole first VMG menu domain in the VMG space. The <object> tag indicates the location of the Vclick stream using a “data” attribute. For example, in the embodiment of the present invention, the location of the Vclick stream is designated by “http://www.vclick.com/dvd_enav/vclick2.vck”.

Note that “http://www.vclick.com/dvd_enav/” indicates that the Vclick stream is present in an external server, and “vclick2.vck” indicates the file name of the Vclick stream.

As for a Vclick access table, the location of the Vclick access table is similarly indicated using a “data” attribute in an <object> tag. For example, in the embodiment of the present invention, the location of the Vclick access table is designated by “http://www.vclick.com/dvd_enav/vclick2.ifo”. Note that “http://www.vclick.com/dvd_enav/” indicates that the Vclick access table is present in an external server, and “vclick2.ifo” indicates the file name of the Vclick access table.

The third Vclick stream is designated using an <object> tag in <pgc num=“1”> in <vts_tt num=“1”> in <vts num=“1”>. This indicates that the Vclick stream designated by the <object> tag is appended to the first PGC in the first title domain in the first VTS space. In the <object> tag, the location of the Vclick stream is indicated using a “data” attribute. For example, in the embodiment of the present invention, the location of the Vclick stream is designated by “file://dvdrom:/dvd_enav/vclick3.vck”. Note that “file://dvdrom:/” indicates that the Vclick stream is present in the enhanced DVD disc, “dvd_enav/” indicates that the stream is present under a “DVD_ENAV” directory in the disc, and “vclick3.vck” indicates the file name of the Vclick stream.

The fourth Vclick stream is designated using an <object> tag in <vts_tt num=“n”> in <vts num=“1”>. This indicates that the Vclick stream designated by the <object> tag is appended to the first title domain in the first VTS space. In the <object> tag, the location of the Vclick stream is indicated using a “data” attribute. For example, in the embodiment of the present invention, the location of the Vclick stream is designated by “file://dvdrom:/dvd_enav/vclick4.vck”. Note that “file://dvdrom:/” indicates that the Vclick stream is present in the enhanced DVD disc, “dvd_enav/” indicates that the stream is present under a “DVD_ENAV” directory in the disc, and “vclick4.vck” indicates the file name of the Vclick stream.

The fifth Vclick stream is designated using an <object> tag in <vtsm num=“n”> in <vts num=“1”>. This indicates that the Vclick stream designated by the <object> tag is appended to the first VTS menu domain in the first VTS space. In the <object> tag, the location of the Vclick stream is indicated using a “data” attribute. For example, in the embodiment of the present invention, the location of the Vclick stream is designated by “file://dvdrom:/dvd_enav/vclick5.vck”. Note that “file://dvdrom:/” indicates that the Vclick stream is present in the enhanced DVD disc, “dvd_enav/” indicates that the stream is present under a “DVD_ENAV” directory in the disc, and “vclick5.vck” indicates the file name of the Vclick stream.

The sixth Vclick stream is designated using an <object> tag in <pgc num=“1”> in <vtsm num=“n”> in <vts num=“1”>. This indicates that the Vclick stream designated by the <object> tag is appended to the first PGC in the first VTS menu domain in the first VTS space. In the <object> tag, the location of the Vclick stream is indicated using a “data” attribute. For example, in the embodiment of the present invention, the location of the Vclick stream is designated by “file://dvdrom:/dvd_enav/vclick6.vck”. Note that “file://dvdrom:/” indicates that the Vclick stream is present in the enhanced DVD disc, “dvd_enav/” indicates that the stream is present under a “DVD_ENAV” directory in the disc, and “vclick6.vck” indicates the file name of the Vclick stream.

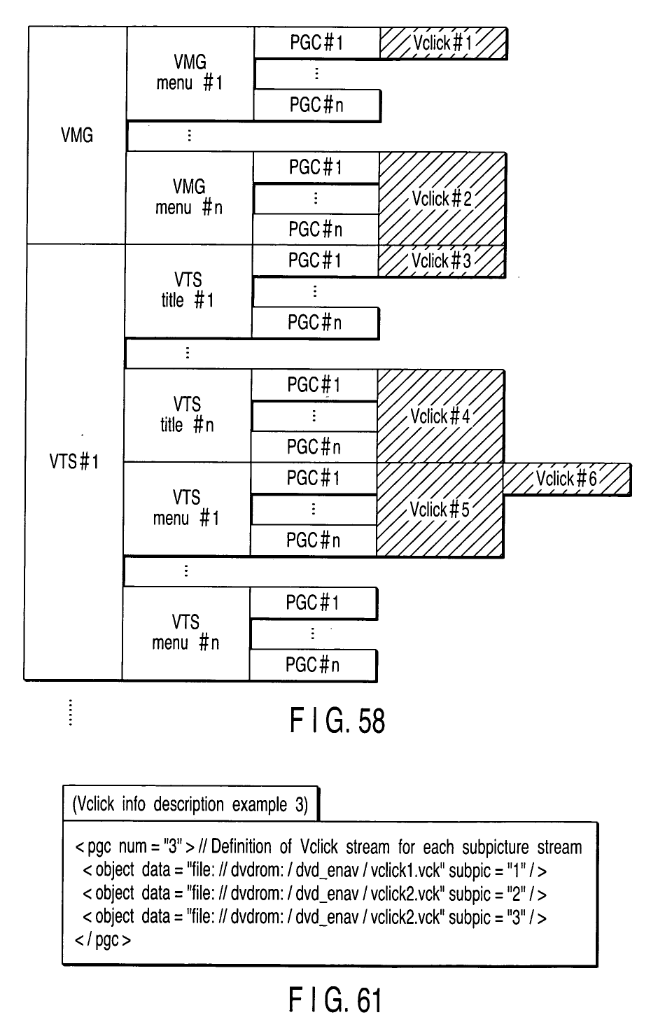

FIG. 58 shows the relationship between the Vclick streams described in the above Vclick Info description example, and the DVD video contents. As can be seen from FIG. 58, the aforementioned fifth and sixth Vclick streams are appended to the first PGC in the first VTS menu domain in the first VTS space. This represents that two Vclick streams are appended to the DVD video contents, and can be switched by, e.g., the user or contents provider (contents author).

When the user switches these streams, a “Vclick switch button” used to switch the Vclick streams is provided to a remote controller (not shown). With this button, the user can freely change two or more Vclick streams. When the contents provider changes these streams, a Vclick switching command (“changeVclick( )”) is described in a Markup language, and this command is issued at a timing designated by the contents provider in the Markup language, thus freely changing two or more Vclick streams.

FIGS. 59 to 65 show other description examples (seven examples) of the Vclick information file. In the first example (FIG. 59), two Vclick streams (Vclick streams #1 and #2) recorded on the disc and one Vclick stream (Vclick stream #3) recorded on the server are appended to one PGC (PGC #1). As described above, these Vclick streams #1, #2, and #3 can be freely switched by the user and also by the contents provider.

Upon switching Vclick streams by the contents provider, for example, when the playback apparatus is instructed to play back Vclick stream #3 but is connected to the external server, or when it is connected to the external server but cannot download Vclick stream #3 from the external server, Vclick stream #1 or #2 may be played back instead. A “priority” attribute in the <object> tag indicates an order upon switching streams. For example, when the user (using “Vclick switch button”) or the contents provider (using the Vclick switching command “changeVclick( )”) sequentially switches Vclick streams, as described above, the Vclick streams are switched like Vclick stream #1→Vclick stream #2→Vclick stream #3→Vclick stream #1→ . . . with reference to the order in the “priority” attribute.

The contents provider can also select an arbitrary Vclick stream by issuing a command at a timing designated in the Markup language using a Vclick switching command (“changeVclick(priority)”). For example, when a “changeVclick(2)” command is issued, Vclick stream #2 with a “priority” attribute=“2” is played back.

In the next example (FIG. 60), two Vclick streams (Vclick streams #1 and #2) recorded on the disc are appended to one PGC (PGC #2). Note that an “audio” attribute in the <object> tag corresponds to an audio stream number. This example indicates that when audio stream #1 of the DVD video contents is played back, Vclick stream #1 (Vclick1.vck) is played back synchronously, or when audio stream #2 of the DVD video contents is played back, Vclick stream #2 (Vclick2.vck) is played back synchronously.

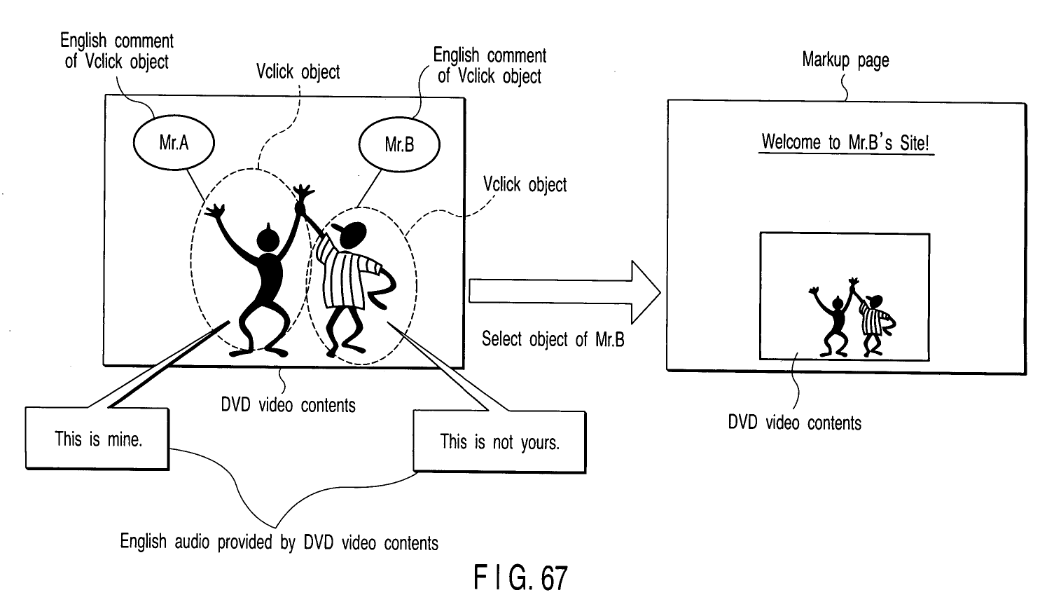

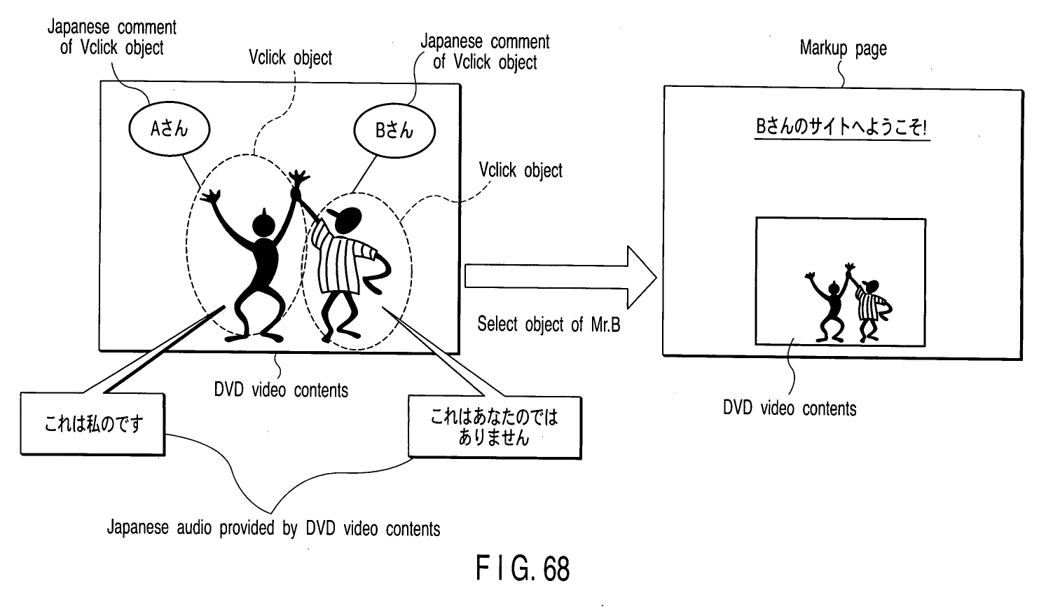

For example, when audio stream #1 of the video contents includes Japanese audio and audio stream #2 includes English audio, Vclick stream #1 is formed in Japanese, as shown in FIG. 68 (that is, a site or page that describes Japanese comments of Vclick objects or a Japanese site or page as an access destination after a Vclick object is clicked), and Vclick stream #2 is formed in English, as shown in FIG. 67 (that is, a site or page that describes English comments of Vclick objects or an English site or page as an access destination after a Vclick object is clicked), thus adjusting the audio language of the DVD video contents to the language of the Vclick stream. In practice, the playback apparatus refers to SPRM(1) (audio stream number) and searches this Vclick information file for a corresponding Vclick stream and plays it back.

In the third example (FIG. 61), three Vclick streams (Vclick streams #1, #2, and #3) recorded on the disc are appended to one PGC (PGC #3). Note that a “subpic” attribute in the <object> tag corresponds to a sub-picture stream number (sub-picture number). This example indicates that when sub-picture stream #1 of the DVD video contents is played back, Vclick stream #1 (Vclick1.vck) is played back synchronously, when sub-picture stream #2 is played back, Vclick stream #2 (Vclick2.vck) is played back synchronously, and when sub-picture stream #3 is played back, Vclick stream #3 (Vclick3.vck) is played back synchronously.

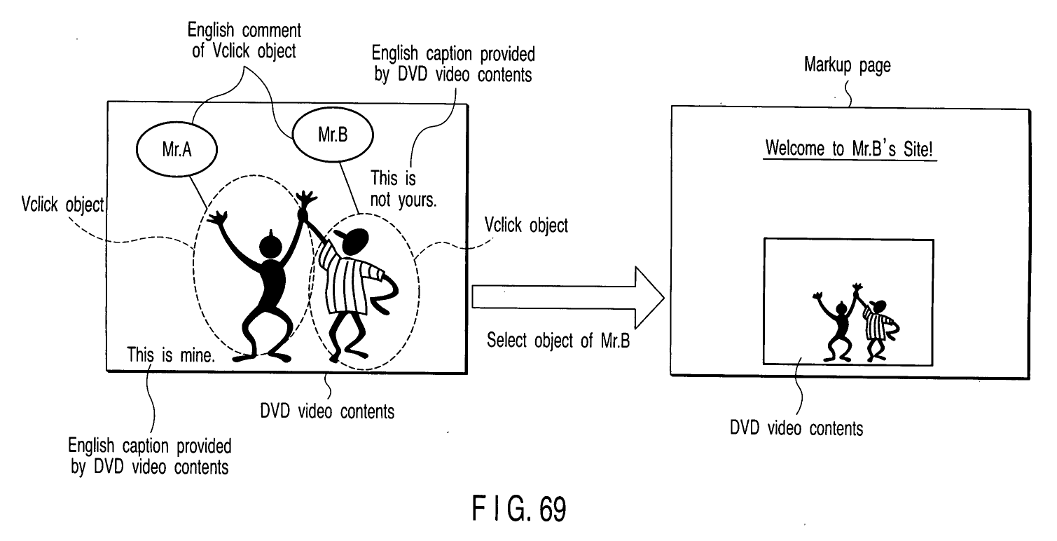

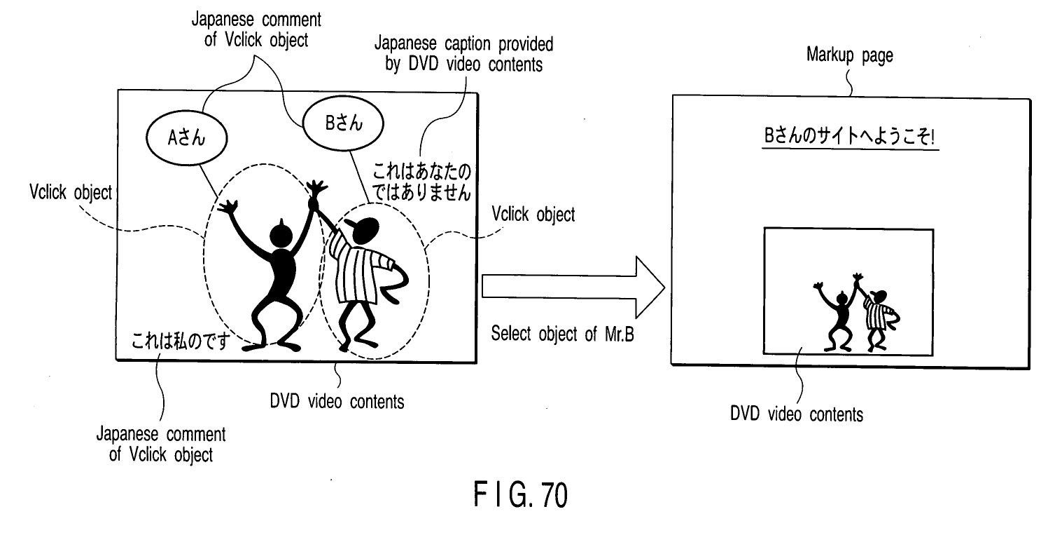

For example, when sub-picture stream #1 includes a Japanese caption and sub-picture stream #3 includes an English caption, Vclick stream #1 is formed in Japanese, as shown in FIG. 70 (that is, a site or page that describes Japanese comments of Vclick objects or a Japanese site or page as an access destination after a Vclick object is clicked), and Vclick stream #3 is formed in English, as shown in FIG. 69 (that is, a site or page that describes English comments of Vclick objects or an English site or page as an access destination after a Vclick object is clicked), thus adjusting the caption language of the DVD video contents to the language of the Vclick stream. In practice, the playback apparatus refers to SPRM(2) (sub-picture stream number) and searches this Vclick information file for a corresponding Vclick stream and plays it back.

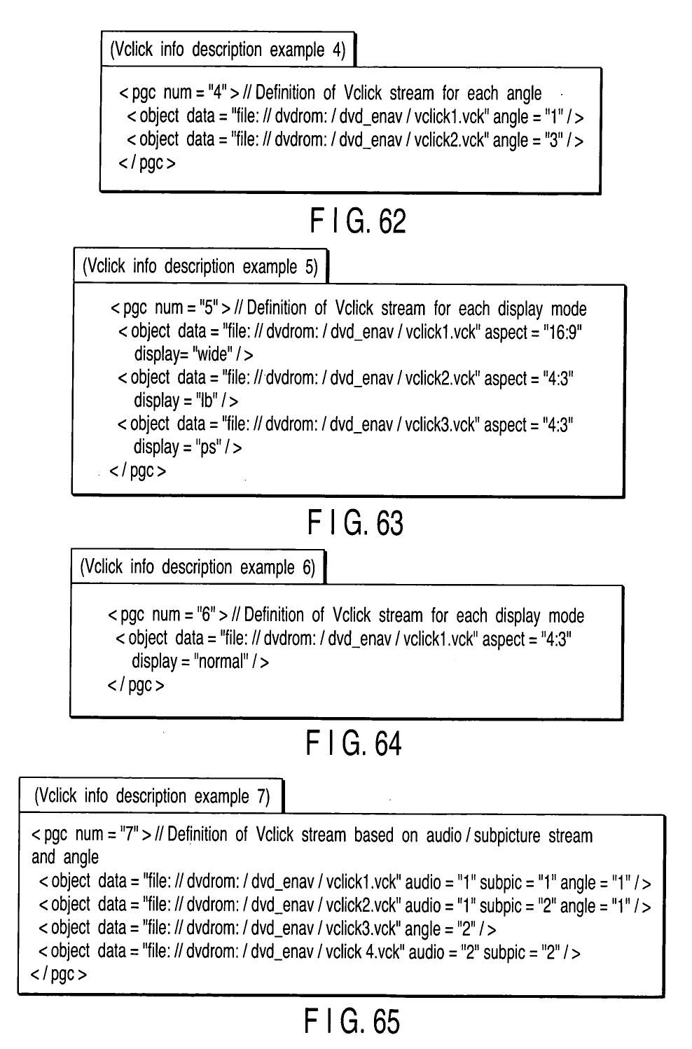

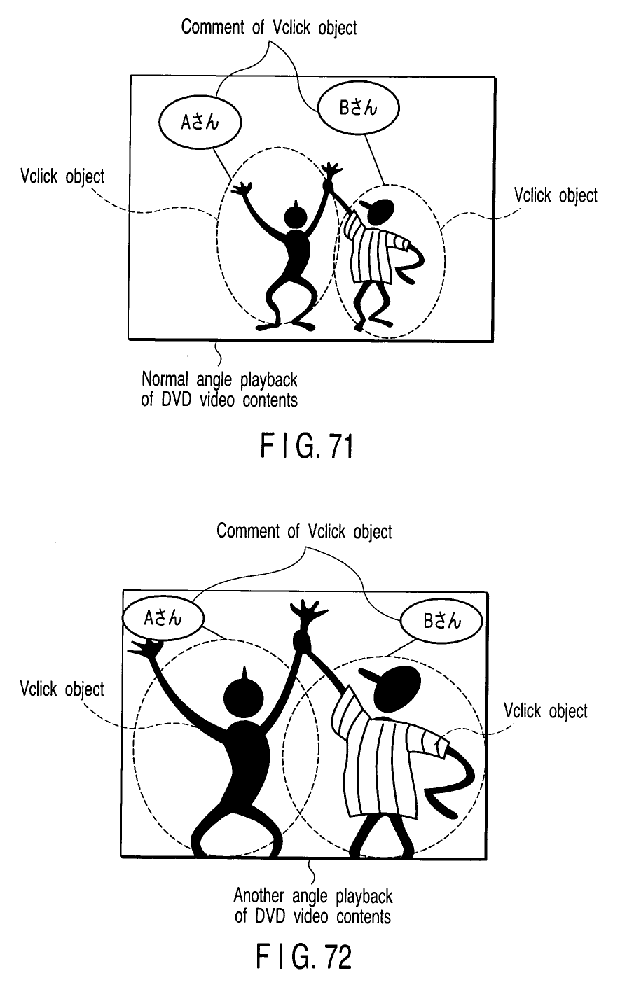

In the fourth example (FIG. 62), two Vclick streams (Vclick streams #1 and #2) recorded on the disc are appended to one PGC (PGC #4). Note that an “angle” attribute in the <object> tag corresponds to an angle number. This example indicates that when angle #1 of the video contents is played back, Vclick stream #1 (Vclick1.vck) is played back synchronously (FIG. 71), when angle #3 is played back, Vclick stream #2 (Vclick2.vck) is played back synchronously (FIG. 2), and when angle #2 is played back, no Vclick stream is played back. Normally, when angles are different, the positions of persons and the like to which Vclick objects are to be appended are different. Therefore, Vclick streams must be formed for respective angles. (Respective Vclick object data may be multiplexed on one Vclick stream.) In practice, the playback apparatus refers to SPRM(3) (angle number) and searches this Vclick information file for a corresponding Vclick stream and plays it back.

In the fifth example (FIG. 63), three Vclick streams (Vclick streams #1, #2, and #3) recorded on the disc are appended to one PGC (PGC #5). Note that an “aspect” attribute in the <object> tag corresponds to a (default) display aspect ratio, and a “display” attribute in the <object> tag corresponds to a (current) display mode.

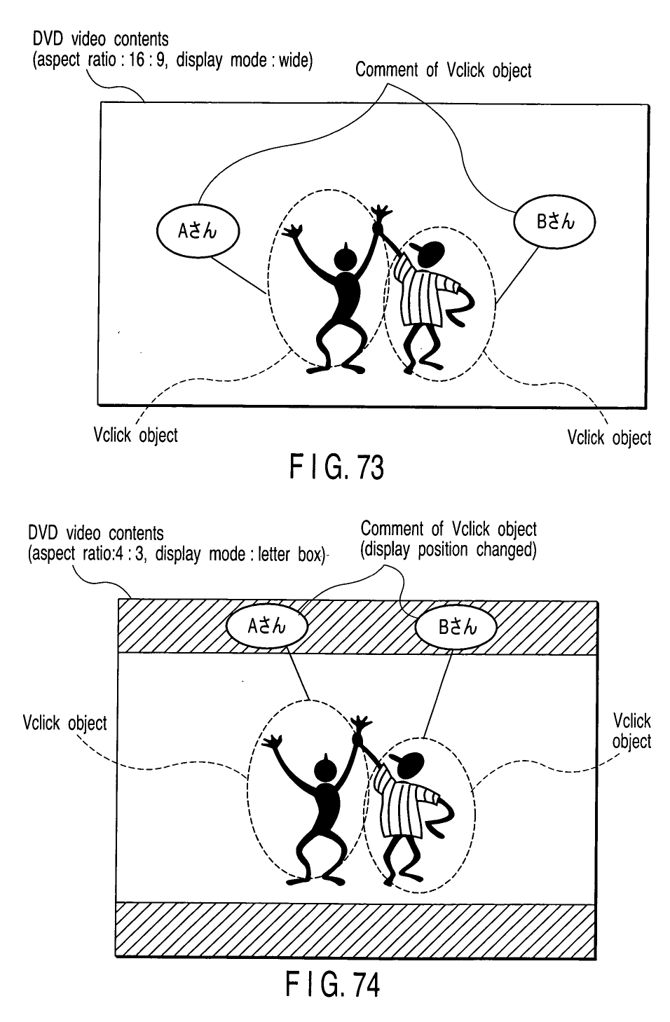

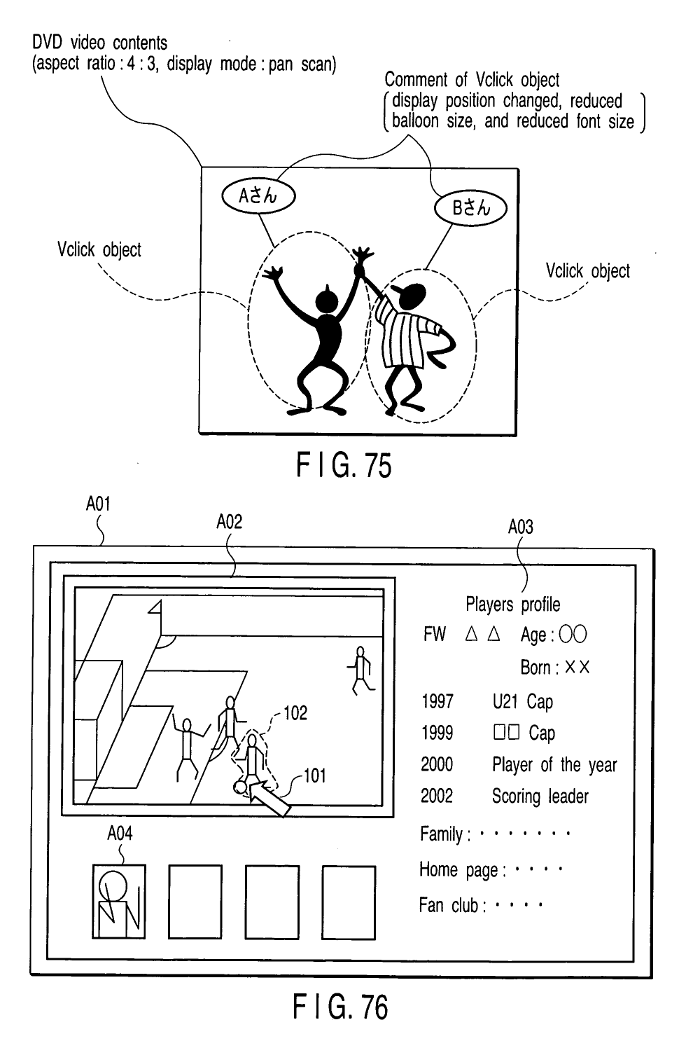

This example indicates that the DVD video contents themselves have a “16:9” aspect ratio, and are allowed to make a “wide” output to a TV monitor having a “16:9” aspect ratio, and a “letter box (lb)” or “pan scan (ps)” output to a TV monitor having a “4:3” aspect ratio. By contrast, when the (default) display aspect ratio is “16:9” and the (current) display mode is “wide”, Vclick stream #1 is played back synchronously (FIG. 73), when the (default) display aspect ratio is “4:3” and the (current) display mode is “lb”, Vclick stream #2 is played back synchronously (FIG. 74), and when the (default) display aspect ratio is “4:3” and the (current) display mode is “ps”, Vclick stream #3 is played back synchronously (FIG. 75). For example, a balloon as a Vclick object, which is displayed just beside a person, when the video contents are displayed at a “16:9” aspect ratio, can be displayed on the upper or lower (black) portion of the screen in case of “letter box” display at a “4:3” aspect ratio or can be shifted to a displayable position in case of “pan scan” display at a “4:3” aspect ratio although the right and left ends of the screen are not displayed.

Also, the balloon size can be decreased or increased, and the text size in the balloon can be decreased or increased in correspondence with the screen configuration. In this manner, Vclick objects can be displayed in correspondence with the display state of the DVD video contents. In practice, the playback apparatus refers to “default display aspect ratio” and “current display mode” in SPRM(14) (player configuration for video) and searches this Vclick information file for a corresponding Vclick stream and plays it back.

In the sixth example (FIG. 64), one Vclick stream (Vclick stream #1) recorded on the disc is appended to one PGC (PGC #6). As in the above example, an “aspect” attribute in the <object> tag corresponds to a (default) display aspect ratio, and a “display” attribute in the <object> tag corresponds to a (current) display mode. In this example, the DVD video contents themselves have a “4:3” aspect ratio, and the Vclick stream is applied to a TV monitor having a “4:3” aspect ratio when the contents are output in a “normal” mode.

Finally, the aforementioned functions can be used in combination as shown in an example (FIG. 65). Four Vclick streams (Vclick streams #1, #2, #3, and #4) recorded on the disc are appended to one PGC (PGC #7). In this example, when audio stream #1, sub-picture stream #1, and angle #1 of the DVD video contents are played back, Vclick stream #1 (Vclick1.vck) is played back synchronously; when audio stream #1, sub-picture stream #2, and angle #1 are played back, Vclick stream #2 (Vclick2.vck) is played back synchronously; when angle #2 is played back, Vclick stream #3 (Vclick3.vck) is played back synchronously; and when audio stream #2 and sub-picture stream #2 are played back, Vclick stream #4 (Vclick4.vck) is played back synchronously.

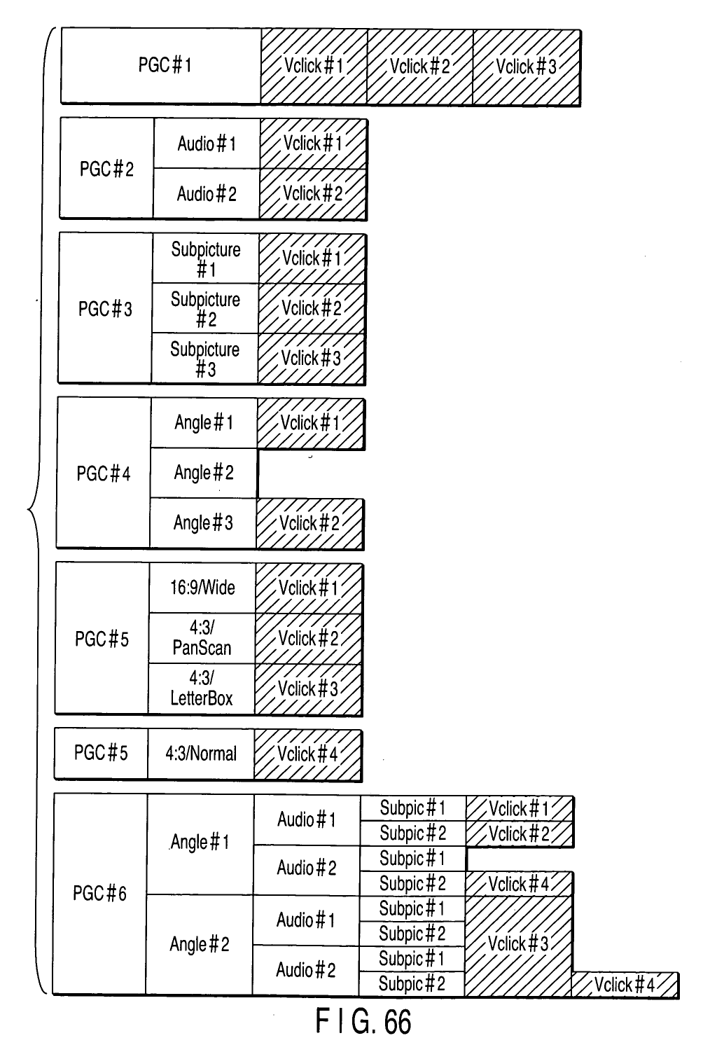

FIG. 66 shows the relationship between the PGC data of the DVD video contents and Vclick streams to be appended to their attributes in association with the seven examples (FIGS. 59 to 65).

The playback apparatus (enhanced DVD player) according to the embodiment of the present invention can sequentially change Vclick streams to be appended in correspondence with the playback state of the DVD video contents by loading the Vclick information file in advance or referring to that file as needed, prior to playback of the DVD video contents. In this manner, a high degree of freedom can be assured upon forming Vclick streams, and the load on authoring can be reduced.

By increasing the number of files (the number of streams) of unitary Vclick contents, and decreasing each file size, an area (buffer) required for the playback apparatus to store Vclick streams can be reduced.

By decreasing the number of files (i.e., forming one stream to include a plurality of Vclick data) although the file size increases, Vclick data can be switched smoothly when the playback state of the DVD video contents has changed.

(Overview of Data Structure and Access Table)

A Vclick stream includes data associated with a region of an object (e.g., a person, article, or the like) that appears in the moving picture recorded on moving picture data recording medium 231, a display method of the object in client 200, and data of an action to be taken by the client when the user designates that object. An overview of the structure of Vclick data and its elements will be explained below.

Object region data as data associated with a region of an object (e.g., a person, article, or the like) that appears in the moving picture will be explained first.

FIG. 3 is a view for explaining the structure of object region data. Reference numeral 300 denotes a locus, which is formed by a region of one object, and is expressed on a three-dimensional (3D) coordinate system of X (the horizontal coordinate value of a video picture), Y (the vertical coordinate value of the video picture), and Z (the time of the video picture). An object region is converted into object region data for each predetermined time range (e.g., between is 0.5 sec to 1.0 sec, between 2 sec to 5 sec, or the like). In FIG. 3, one object region 300 is converted into five object region data 301 to 305, which are stored in independent Vclick access units (AU: to be described later). As a conversion method at this time, for example, MPEG-4 shape encoding, an MPEG-7 spatio-temporal locator, or the like can be used. Since the MPEG-4 shape encoding and MPEG-7 spatio-temporal locator are schemes for reducing the data size by exploiting temporal correlation among object regions, they suffer problems: data cannot be decoded halfway, and if data at a given time is omitted, data at neighboring times cannot be decoded. Since the region of the object that continuously appears in the moving picture for a long period of time, as shown in FIG. 3, is converted into data by dividing it in the time direction, easy random access is allowed, and the influence of omission of partial data can be reduced. Each Vclick_AU is effective in only a specific time interval in a moving picture. The effective time interval of Vclick_AU is called a lifetime of Vclick_AU.

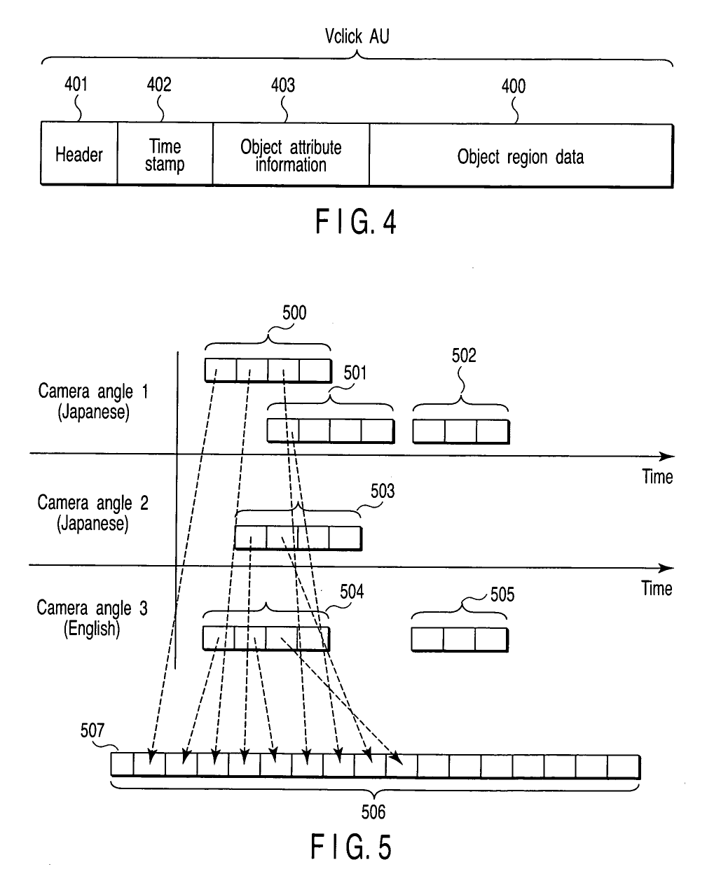

FIG. 4 shows the structure of one unit (Vclick_AU), which can be accessed independently, in a Vclick stream used in the embodiment of the present invention. Reference numeral 400 denotes object region data. As has been explained using FIG. 3, the locus of one object region in a given time interval is converted into data. The time interval in which the object region is described is called an active time of that Vclick_AU. Normally, the active time of Vclick_AU is equal to the lifetime of that Vclick_AU. However, the active time of Vclick_AU can be set as a part of the lifetime of that Vclick_AU.

Reference numeral 401 denotes a header of Vclick_AU. The header 401 includes an ID used to identify Vclick_AU, and data used to specify the data size of that AU. Reference numeral 402 denotes a time stamp which indicates that of the start of the lifetime of this Vclick_AU. Since the active time and lifetime of Vclick_AU are normally equal to each other, the time stamp also indicates a time of the moving picture corresponding to the object region described in the object region data. As shown in FIG. 3, since the object region covers a certain time range, the time stamp 402 normally describes the time of the head of the object region. Of course, the time stamp may describe the time interval or the time of the end of the object region described in the object region data. Reference numeral 403 denotes object attribute information, which includes, e.g., the name of an object, an action description upon designation of the object, a display attribute of the object, and the like. These data in Vclick_AU will be described in detail later. The server preferably records Vclick_AUs in the order of time stamps so as to facilitate transmission.

FIG. 5 is a view for explaining the method of generating a Vclick stream by arranging a plurality of AUs in the order of time stamps. In FIG. 5, assume that there are two camera angles, i.e., camera angles 1 and 2, and a moving picture to be displayed is switched when the camera angle is switched at the client. Also, assume that there are two selectable language modes: Japanese and English, and different Vclick data are prepared in correspondence with these languages.

Referring to FIG. 5, Vclick_AUs for camera angle 1 and Japanese are 500, 501, and 502, and that for camera angle 2 and Japanese is 503. Also, Vclick_AUs for English are 504 and 505. Each of the AUs 500 to 505 is data corresponding to one object in the moving picture. That is, as has been explained above using FIGS. 3 and 4, meta data associated with one object is made up of a plurality of Vclick_AUs (in FIG. 5, one rectangle represents one AU). The abscissa of FIG. 5 corresponds to a time in the moving picture, and the AUs 500 to 505 are plotted in correspondence with the times of appearance of the objects.

Temporal divisions of respective Vclick_AUs may be arbitrarily determined. However, when the divisions of Vclick_AUs are aligned to all objects, as shown in FIG. 5, data management becomes easy. Reference numeral 506 denotes a Vclick stream formed of these Vclick_AUs (500 to 505). The Vclick stream is formed by arranging Vclick_AUs in the order of time stamps after a header 507.

Since the selected camera angle is more likely to be switched by the user during viewing, the Vclick stream is preferably prepared by multiplexing Vclick_AUs of different camera angles. This is because quick display switching is allowed at the client. For example, when Vclick data is stored in server 201, if a Vclick stream including Vclick_AUs of a plurality of camera angles is transmitted intact to the client, since Vclick_AU corresponding to a currently viewed camera angle always arrives the client, a camera angle can be switched instantaneously. Of course, setup information of client 200 may be sent to server 201, and only required Vclick_AU may be selectively transmitted from a Vclick stream. In this case, since the client must communicate with the server, the process delays slightly (although this process delay problem can be solved if high-speed means such as an optical fiber or the like is used in a communication).

On the other hand, since attributes such as a moving picture title, PGC of DVD video, the aspect ratio of the moving picture, viewing region, and the like are not so frequently changed, they are preferably prepared as independent Vclick streams so as to lighten the process of the client and to reduce the load on the network. A Vclick stream to be selected of a plurality of Vclick streams can be determined with reference to the Vclick information file, as has already been described above.

Another Vclick_AU selection method will be described below. A case will be examined below wherein the client downloads Vclick stream 506 from the server, and uses only required AUs on the client side. In this case, IDs used to identify required Vclick_AUs may be assigned to respective AUs. Such ID is called a filter ID.

The conditions of required AUs are described in, e.g., the Vclick information file as follows. Note that the Vclick information file may be present on moving picture data recording medium 231 or may be downloaded from server 201 via the network. The Vclick information file is normally supplied from the same medium as that of the Vclick streams such as the moving picture data recording medium, server, or the like:

<pgc num=“7”>
//audio/definition of Vclick stream by subpicture
stream and angle
<object data=“file://dvdrom:/dvd_enav/vclick1.vck”
audio=“1” subpic=“1” angle=“1”/>
<object data=“file://dvdrom:/dvd_enav/vclick1.vck”
audio=“3” subpic=“2” angle=“1”/>
</pgc>

In this case, two different filtering conditions are described for one Vclick stream. This indicates that two different Vclick_AUs having different attributes can be selected from a single Vclick stream in accordance with the setups of system parameters at the client.

If AUs have no filter IDs, meta data manager 210 checks the time stamps, attributes, and the like of AUs to select AUs that match the given conditions, thereby identifying required Vclick_AUs.

An example using the filter IDs will be explained according to the above description. In the above conditions, “audio” represents an audio stream number, which is expressed by a 4-bit numerical value. Likewise, 4-bit numerical values are assigned to sub-picture number subpic and angle number angle. In this way, the states of three parameters can be expressed by a 12-bit numerical value. That is, three parameters audio=“3”, subpic=“2”, and angle=“1” can be expressed by 0x321 (hex). This value is used as a filter ID. That is, each Vclick_AU has a 12-bit filter ID in a Vclick_AU header (see filtering_id in FIG. 14). This method defines a filter ID as a combination of numerical values by assigning numerical values to independent parameter values used to identify each AU. Note that the filter ID may be described in a field other than the Vclick_AU header.

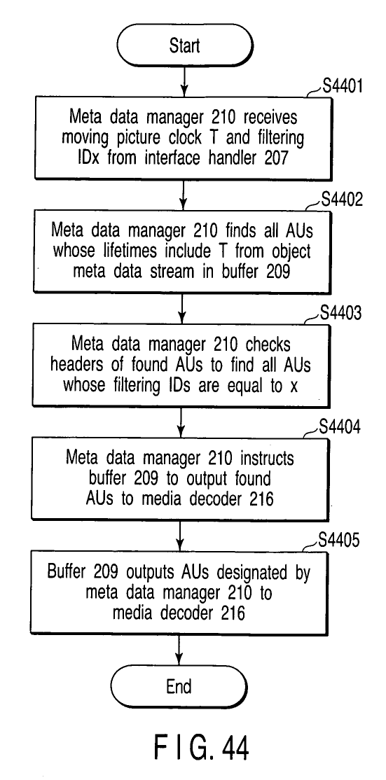

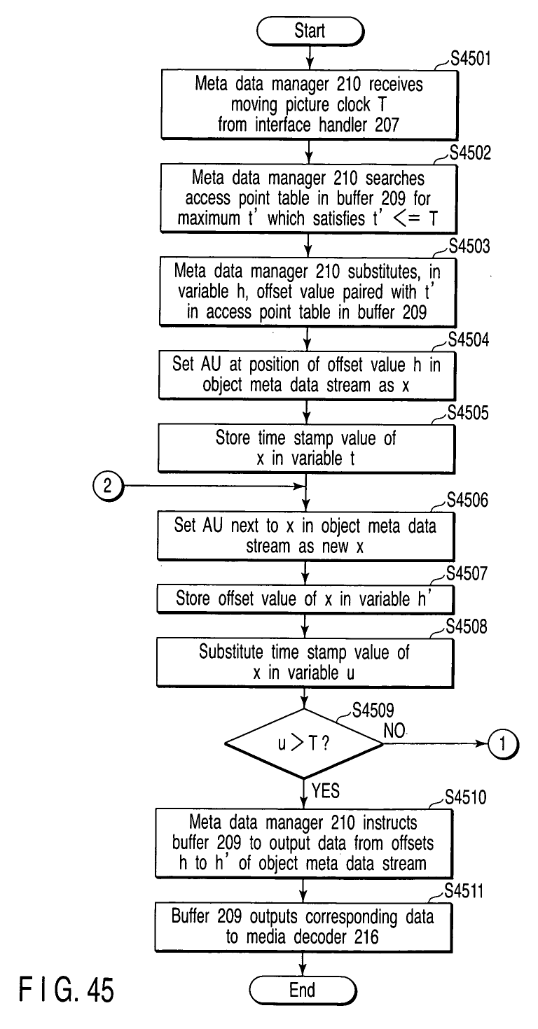

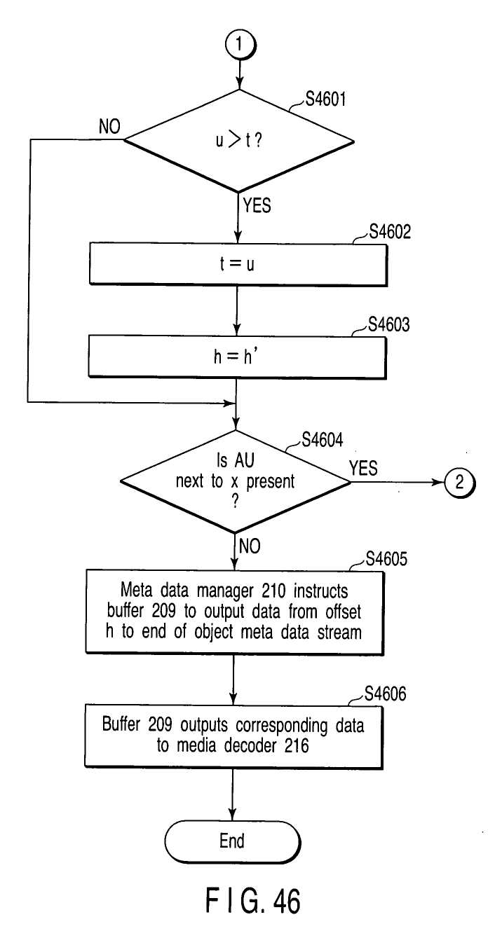

FIG. 44 shows the filtering operation of the client. Meta data manager 210 receives moving picture clock value T and filter ID x from interface handler 207 (step S4401). Meta data manager 210 finds out all Vclick_AUs whose lifetimes include moving picture clock value T from a Vclick stream stored in buffer 209 (step S4402). In order to find out such AUs, procedures shown in FIGS. 45 and 46 can be used using the Vclick access table. Meta data manager 210 checks the Vclick_AU headers, and sends only AUs with the same filter ID as x to media decoder 216 (steps S4403 to S4405).

Vclick_AUs which are sent from buffer 209 to meta data decoder 217 with the aforementioned procedures have the following properties:

i) All these AUs have the same lifetime, which includes moving picture clock T.

ii) All these AUs have the same filter ID x.

AUs in the object meta data stream which satisfy the above conditions i) and ii) are not present except for these AUs.

In the above description, the filter ID is defined by a combination of values assigned to parameters. Alternatively, the filter ID may be directly designated in the Vclick information file. For example, the filter ID is defined in an IFO file as follows:

<pgc num=“5”>
<param angle=“1”>
<object data=“file://dvdrom:/dvd_enav/vclick1.vck”
filter_id=“3”/>
</param>
<param angle=“3”>
<object data=“file://dvdrom:/dvd_enav/vclick2.vck”
filter_id=“4”/>
</param>
<param aspect=“16:9” display=“wide”>
<object data=“file://dvdrom:/dvd_enav/vclick1.vck”
filter_id=“2”/>
</param>
</pgc>

The above description indicates that Vclick streams and filter ID values are determined based on designated parameters. Selection of Vclick_AUs by the filter ID and transfer of AUs from buffer 209 to media decoder 217 are done in the same procedures as in FIG. 44. Based on the designation of the Vclick information file, when the angle number of the player is “3”, only Vclick_AUs whose filter ID value is equal to “4” are sent from a Vclick stream stored in file “vclick2.vck” in buffer 209 to media decoder 217.

When Vclick data is stored in server 201, and a moving picture is to be played back from its head, server 201 need only distribute a Vclick stream in turn from the head to the client. However, if a random access has been made, data must be distributed from the middle of the Vclick stream. At this time, in order to quickly access a desired position in the Vclick stream, a Vclick access table is required.

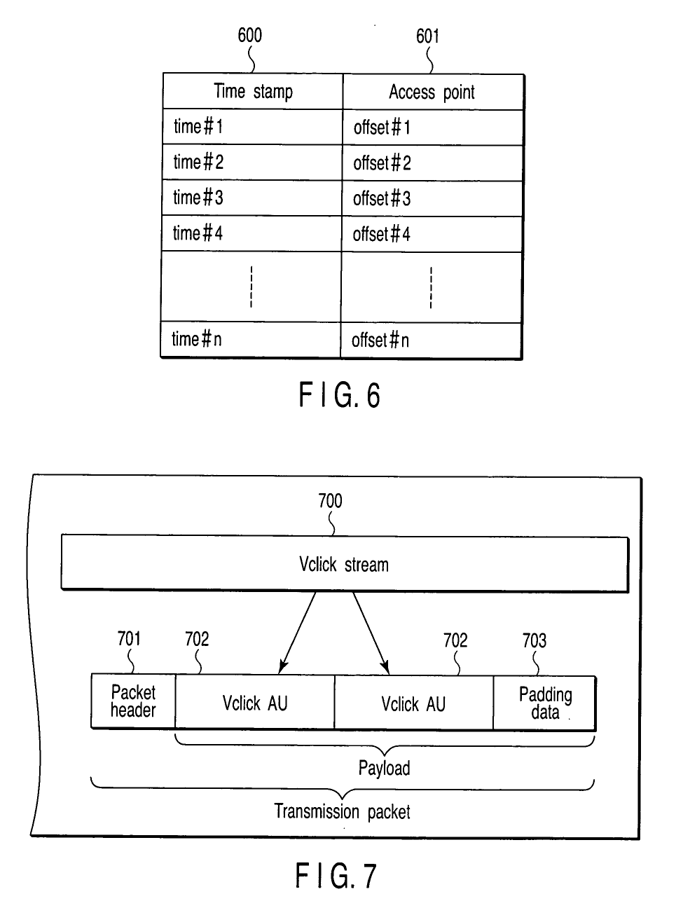

FIG. 6 shows an example of the Vclick access table. This table is prepared in advance, and is recorded in server 201. This table can also be stored in the Vclick information file. Reference numeral 600 denotes a time stamp sequence, which lists time stamps of the moving picture. Reference numeral 601 denotes an access point sequence, which lists offset values from the head of a Vclick stream in correspondence with the time stamps of the moving picture. If a value corresponding to the time stamp of the random access destination of the moving image is not stored in the Vclick access table, an access point of a time stamp with a value close to that time stamp is referred to, and a transmission start location is sought while referring to time stamps in the Vclick stream near that access point. Alternatively, the Vclick access table is searched for a time stamp of a time before that of the random access destination of the moving image, and the Vclick stream is transmitted from an access point corresponding to the time stamp.

The server stores the Vclick access table and uses it for convenience to search for Vclick data to be transmitted in response to random access from the client. However, the Vclick access table stored in the server may be downloaded to the client, which may search for a Vclick stream. Especially, when Vclick streams are simultaneously downloaded from the server to the client, Vclick access tables are also simultaneously downloaded from the server to the client.

On the other hand, a moving picture recording medium such as a DVD or the like which records Vclick streams may be provided. In this case as well, it is effective for the client to use the Vclick access table so as to search for data to be used in response to random access of playback contents. In such case, the Vclick access tables are recorded on the moving picture recording medium as in Vclick streams, and the client reads out and uses the Vclick access table of interest from the moving picture recording medium onto its internal main memory or the like.

Random playback of Vclick streams, which is produced upon random playback of a moving picture or the like, is processed by meta data decoder 217. In the Vclick access table shown in FIG. 6, time stamp time is time information which has a time stamp format of a moving picture recorded on the moving picture recording medium. For example, when the moving picture is compressed by MPEG-2 upon recording, time has an MPEG-2 PTS format. Furthermore, when the moving picture has a navigation structure of titles, program chains, and the like as in DVD, parameters (TTN, VTS_TTN, TT_PGCN, PTTN, and the like) that express them are included in the format of time.

Assume that some natural totally ordered relation-ship is defined for a set of time stamp values. For example, as for PTS, a natural ordered relationship as a time can be introduced. As for time stamps including DVD parameters, the ordered relationship can be introduced according to a natural playback order of the DVD. Each Vclick stream satisfies the following conditions:

i) Vclick_AUs in the Vclick stream are arranged in ascending order of time stamp. At this time, the lifetime of each Vclick_AU is determined as follows: Let t be the time stamp value of a given AU. Time stamp values u of AUs after the given AU satisfy u>=t. Let t′ be a minimum one of such “u”s, which satisfies u≠t. A period which has time t as the start time and t′ as the end time is defined as the lifetime of the given AU. If there is no AU which has time stamp value u that satisfies u>t after the given AU, the end time of the lifetime of the given AU matches the end time of the moving picture.

ii) The active time of each Vclick_AU corresponds to the time range of the object region described in the object region data included in that Vclick_AU.

Note that the following constraint associated with the active time for a Vclick stream:

The active time of Vclick_AU is included in the lifetime of that AU.

A Vclick stream which satisfies the above constraints i) and ii) has the following good properties: First, high-speed random access of the Vclick stream can be made, as will be described later. Second, a buffer process upon playing back the Vclick stream can be simplified. The buffer stores the Vclick stream for respective Vclick_AUs, and erases AUs from those which have larger time stamps. If there are no two assumptions above, a large buffer and complicated buffer management are required so as to hold effective AUs on the buffer. The following description will be given under the assumption that the Vclick stream satisfies the above two conditions i) and ii).

In the Vclick access table shown in FIG. 6, access point offset indicates a position on a Vclick stream. For example, the Vclick stream is a file, and offset indicates a file pointer value of that file. The relationship of access point offset, which forms a pair with time stamp time, is as follows:

i) A position indicated by offset is the head position of given Vclick_AU.

ii) A time stamp value of that AU is equal to or smaller than the value of time.

iii) A time stamp value of AU immediately before that AU is truly smaller than time.

In the Vclick access table, “time”s may be arranged at arbitrary intervals but need not be arranged at equal intervals. However, they may be arranged at equal intervals in consideration of convenience for a search process and the like.

FIGS. 45 and 46 show the practical search procedures using the Vclick access table. When a Vclick stream is downloaded in advance from the server to buffer 209, a Vclick access table is also downloaded from the server and is stored in buffer 209. When both the Vclick stream and Vclick access table are stored in moving picture data recording medium 231, they are loaded from disc device 230 and are stored in buffer 209.

Upon reception of moving picture clock T from interface handler 207 (step S4501), meta data manager 210 searches time of the Vclick access table stored in buffer 209 for maximum time t′ which satisfies t′<=T (step S4502). A high-speed search can be conducted using, e.g., binary search as a search algorithm. The offset value which forms a pair with obtained time t′ in the Vclick access table is substituted in variable h (step S4503). Meta data manager 210 finds AUx which is located at the h-th byte position from the head of the Vclick stream stored in buffer 209 (step S4504), and substitutes the time stamp value of x in variable t (step S4505). According to the aforementioned conditions, since t is equal to or smaller than t′, t<=T.

Meta data manager 210 checks Vclick_AUs in the Vclick stream in turn from x and sets the next AU as new x (step S4506). The offset value of x is substituted in variable h′ (step S4507), and the time stamp value of x is substituted in variable u (step S4508). If u>T (YES in step S4509), meta data manager 210 instructs buffer 209 to send data from offsets h to h′ of the Vclick stream to media decoder 216 (steps S4510 and S4511). On the other hand, if u<=T (NO in step S4509) and u>T (YES in step S4601), the value of t is updated by u (i.e., t=u) (step S4602). Then, the value of variable h is updated by h′ (i.e., h=h′) (step S4603).

If the next AU is present on the Vclick stream (i.e., if x is not the last AU) (YES in step S4604), the next AU is set as new x to repeat the aforementioned procedures (the flow returns to step S4506 in FIG. 45). If x is the last Vclick_AU of the Vclick stream (NO in step S4604), meta data manager 210 instructs buffer 209 to send data from offset h to the end of the Vclick stream to media decoder 216 (steps S4605 and S4606).

With the aforementioned procedures, Vclick_AUs sent from buffer 209 to media decoder 216 apparently have the following properties:

i) All Vclick_AUs have the same lifetime. In addition, moving picture clock T is included in this lifetime.

ii) Vclick_AUs in the Vclick stream which satisfy the above condition i) are not present except for these AUs.

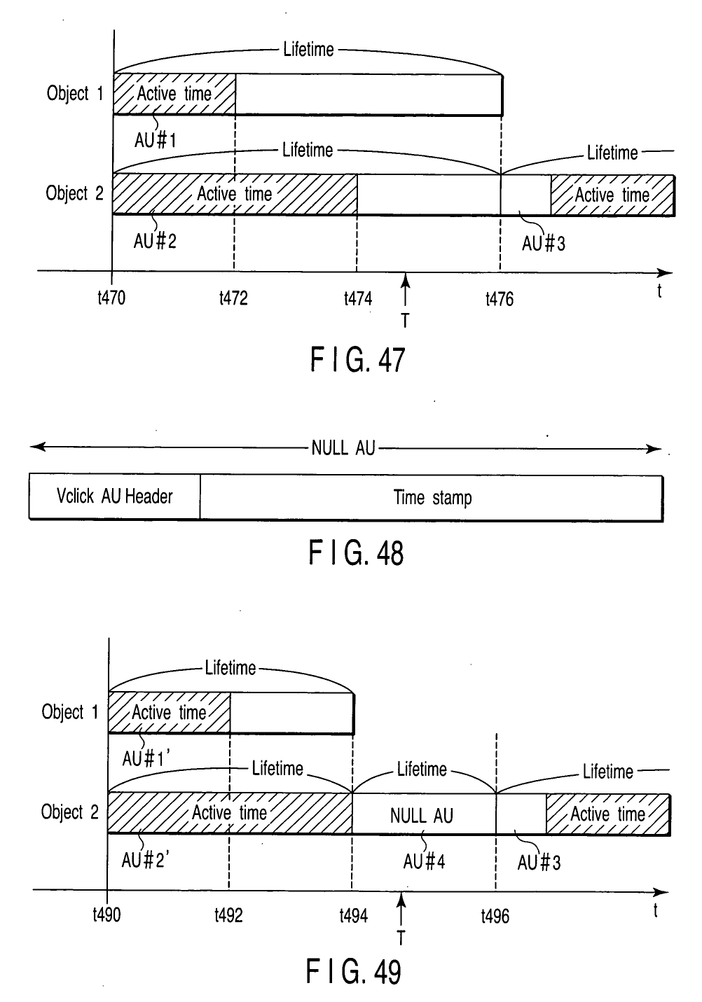

The lifetime of each Vclick_AU in the Vclick stream includes the active time of that AUs, but they do not always match. In practice, a case shown in FIG. 47 is possible. The lifetimes of AU#1 and AU#2 which respectively describe objects 1 and 2 are up to the start time of the lifetime of AU#3. However, the active times of respective AUs do not match their lifetimes.

A Vclick stream in which AUs are arranged in the order of #1, #2, and #3 will be examined. Assume that moving picture clock T is designated. According to the procedures shown in FIGS. 45 and 46, AU#1 and AU#2 are sent from this Vclick stream to media decoder 216. Since media decoder 216 can recognize the active time of the received Vclick_AU, random access can be implemented by this process. However, in practice, since data transfer from buffer 209 and a decode process in media decoder 216 take place during time T in which no object is present, the calculation efficiency drops. This problem can be solved by introducing special Vclick_AU called NULL_AU.

FIG. 48 shows the structure of NULL_AU. NULL_AU does not have any object region data unlike normal Vclick_AU. Therefore, NULL_AU has only a lifetime, but does not have any active time. The header of NULL_AU includes a flag indicating that the AU of interest is NULL_AU. NULL_AU can be inserted in a Vclick stream within a time range where no active time of an object is present.

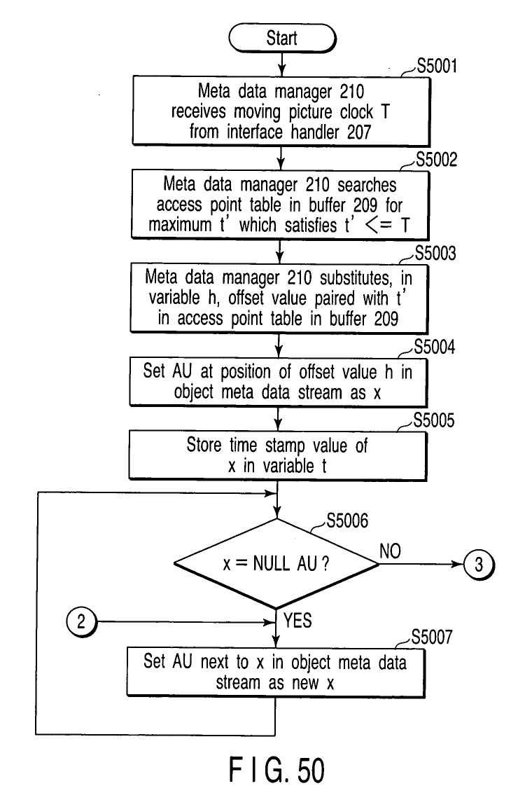

Meta data manager 210 does not output any NULL_AU to media decoder 216. When NULL_AU is introduced, FIG. 47 changes like, for example, FIG. 49. AU#4 in FIG. 49 is NULL_AU. In this case, in a Vclick stream, Vclick_AUs are arranged in the order of AU#1′, AU#2′, AU#4, and AU#3. FIGS. 50, 51, and 52 show the operation of meta data manager 210 corresponding to FIGS. 45 and 46 in association with a Vclick stream including NULL_AU.

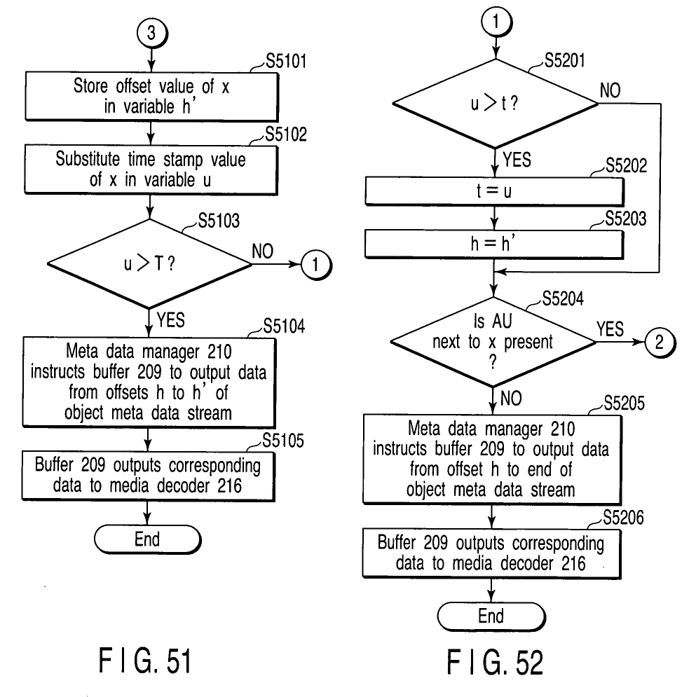

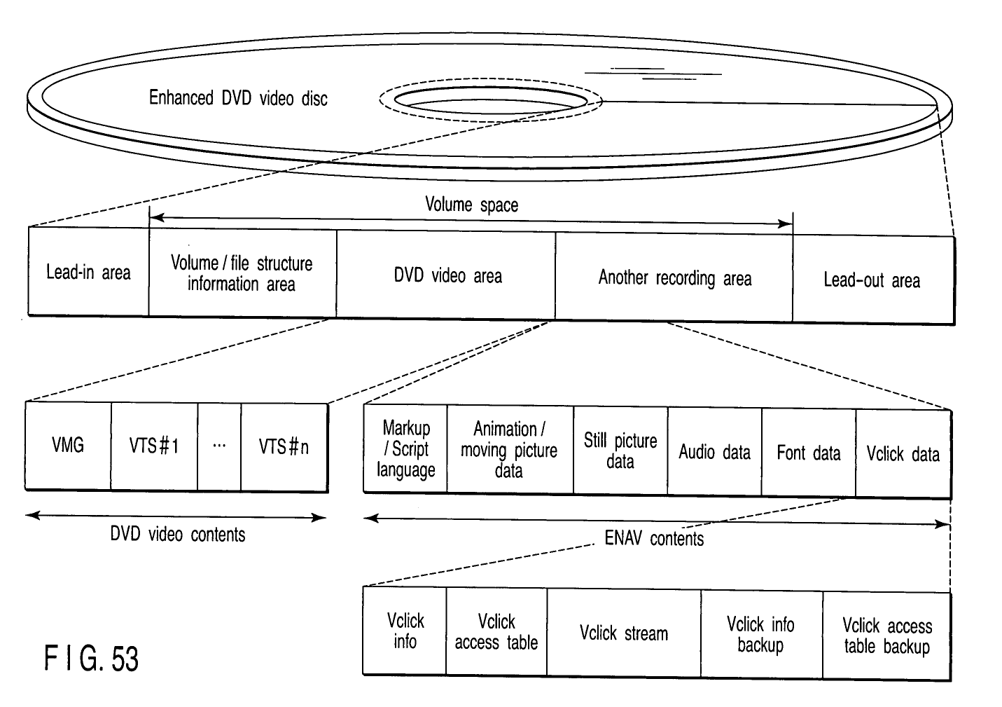

That is, meta data manager 210 receives moving picture clock T from interface manager 207 (step S5001), obtains maximum t′ which satisfies t′<=T (step S5002), and substitutes the offset value which forms a pair with t′ in variable h (step S5003). Access unit AU which is located at the position of offset value h in the object meta data stream is set as x (step S5004), and the time stamp value of x is stored in variable t (step S5005). If x is NULL_AU (YES in step S5006), AU next to x is set as new x (step S5007), and the flow returns to step S5006. If x is not NULL_AU (NO in step S5006), the offset value of x is stored in variable h′ (step S5101). The subsequent processes (steps S5102 to S5105 in FIG. 51 and steps S5201 to S5206 in FIG. 52) are the same as those in steps S4508 to S4511 in FIG. 45 and steps S4601 to S4606 in FIG. 46.

The protocol between the server and client will be explained below. As the protocol used upon transmitting Vclick data from server 201 to client 200, for example, RTP (Real-time Transport Protocol) is known. Since RTP has good chemistry with UDP/IP and attaches importance to realtimeness, packets are likely to be omitted. If RTP is used, a Vclick stream is divided into transmission packets (RTP packets) when it is transmitted. An example of a method of storing a Vclick stream in transmission packets will be explained below.

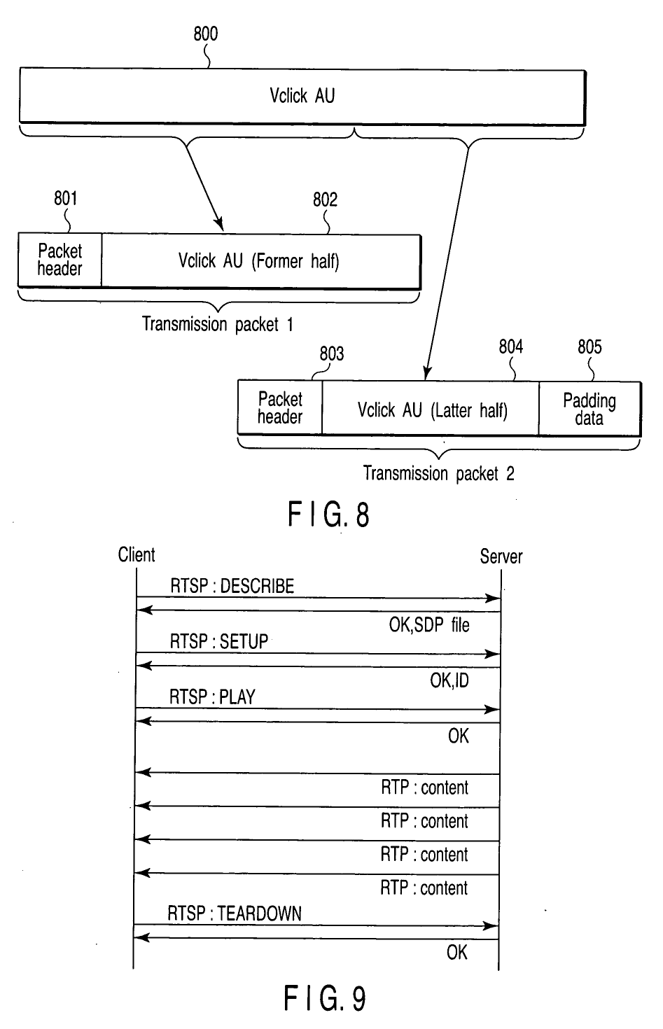

FIGS. 7 and 8 are respectively views for explaining a method of forming transmission packets in correspondence with the small and large data sizes of Vclick_AU, respectively. In FIG. 7, reference numeral 700 denotes a Vclick stream. A transmission packet includes packet header 701 and a payload. Packet header 701 includes the serial number of the packet, transmission time, source specifying information, and the like. The payload is a data area for storing transmission data. Vclick_AUs (702) extracted in turn from Vclick stream 700 are stored in the payload. When the next Vclick_AU cannot be stored in the payload, padding data 703 is inserted in the remaining area. The padding data is dummy data to adjust the data size, and a run of “0” values. When the payload size can be set to be equal to that of one or a plurality of Vclick_AUs, no padding data is required.

On the other hand, FIG. 8 shows a method of forming transmission packets when one Vclick_AU cannot be stored in a payload. Only partial data (802) that can be stored in a payload of the first transmission packet of Vclick_AU (800) is stored in the payload. The remaining data *804) is stored in a payload of the second transmission packet. If the storage size of the payload still has a free space, that space is padded with padding data 805. The same applies to a case wherein one Vclick_AU is divided into three or more packets.

As a protocol other than RTP, HTTP (Hypertext Transport Protocol) or HTTPS may be used. Since HTTP has good chemistry with TCP/IP and omitted data is re-sent, thus allowing highly reliable data communications. However, when the network throughput is low, a data delay may occur. Since HTTP is free from any data omission, a method of dividing a Vclick stream into packets upon storage need not be taken into consideration.

(Playback Procedure (Network))

The procedures of a playback process when a Vclick stream is present on server 201 will be described below.

FIG. 37 is a flowchart showing the playback start process procedures after the user inputs a playback start instruction until playback starts. In step S3700, the user inputs a playback start instruction. This input is received by interface handler 207, which outputs a moving picture playback preparation command to moving picture playback controller 205. It is checked as branch process step S3701 if a session with server 201 has already been opened. If the session has not been opened yet, the flow advances to step S3702; otherwise, the flow advances to step S3703. In step S3702, a process for opening the session between the server and client is executed.

FIG. 9 shows an example of communication procedures from session open until session close when RTP is used as the communication protocol between the server and client. A negotiation must be done between the server and client at the beginning of the session. In case of RTP, RTSP (Real Time Streaming Protocol) is normally used. Since an RTSP communication requires high reliability, RTSP and RTP preferably make communications using TCP/IP and UDP/IP, respectively. In order to open a session, the client (200 in the example of FIG. 2) requests the server (201 in the example of FIG. 2) to provide information associated with Vclick data to be streamed (RTSP DESCRIBE method).

Assume that the client is notified in advance of the address of the server that distributes data corresponding to a moving picture to be played back by a method of, e.g., recording address information on a moving picture data recording medium. The server sends information of Vclick data to the client as a response to this request. More specifically, the client receives information such as the protocol version of the session, session owner, session name, connection information, session time information, meta data name, meta data attributes, and the like. As a method of describing these pieces of information, for example, SDP (Session Description Protocol) is used. The client then requests the server to open a session (RTSP SETUP method). The server prepares for streaming, and returns a session ID. The processes described so far correspond to those in step S3702 when RTP is used.

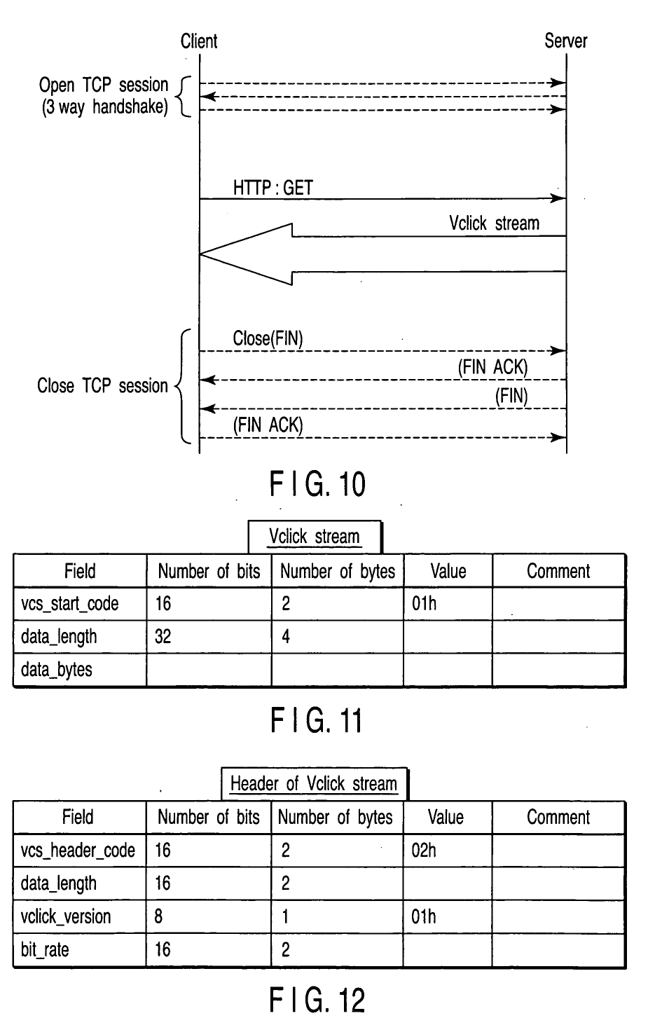

When HTTP is used in place of RTP, the communication procedures are made, as shown in, e.g., FIG. 10. Initially, a TCP session as a lower layer of HTTP is opened (3 way handshake). As in the above procedures, assume that the client is notified in advance of the address of the server which distributes data corresponding to a moving picture to be played back. After that, a process for sending client status information (e.g., a manufacturing country, language, selection states of various parameters, and the like) to the server using, e.g., SDP may be executed. The processes described so far correspond to those in step S3702 in case of HTTP.

In step S3703, a process for requesting the server to transmit Vclick data is executed while the session between the server and client is open. This process is implemented by sending an instruction from the interface handler to network manager 208, and then sending a request from network manager 208 to the server. In case of RTP, network manager 208 sends an RTSP PLAY method to the server to issue a Vclick data transmission request. The server specifies a Vclick stream to be transmitted with reference to information received from the client so far and Vclick Info in the server. Furthermore, the server specifies a transmission start position in the Vclick stream using time stamp information of the playback start position included in the Vclick data transmission request and the Vclick access table stored in the server. The server then packetizes the Vclick stream and sends packets to the client by RTP.

On the other hand, in case of HTTP, network manager 208 transmits an HTTP GET method to issue a Vclick data transmission request. This request may include time stamp information of the playback start position of a moving picture. The server specifies a Vclick stream to be transmitted and the transmission start position in this stream by the same method as in RTP, and sends the Vclick stream to the client by HTTP.

In step S3704, a process for buffering the Vclick stream sent from the server on buffer 209 is executed. This process is done to prevent the buffer from being emptied when Vclick stream transmission from the server is too late. If meta data manager 210 notifies the interface handler that the buffer has stored the sufficient Vclick stream, the flow advances to step S3705. In step S3705, the interface handler issues a moving picture playback start command to controller 205 and also issues a command to meta data manager 210 to start output of the Vclick stream to meta data decoder 217.

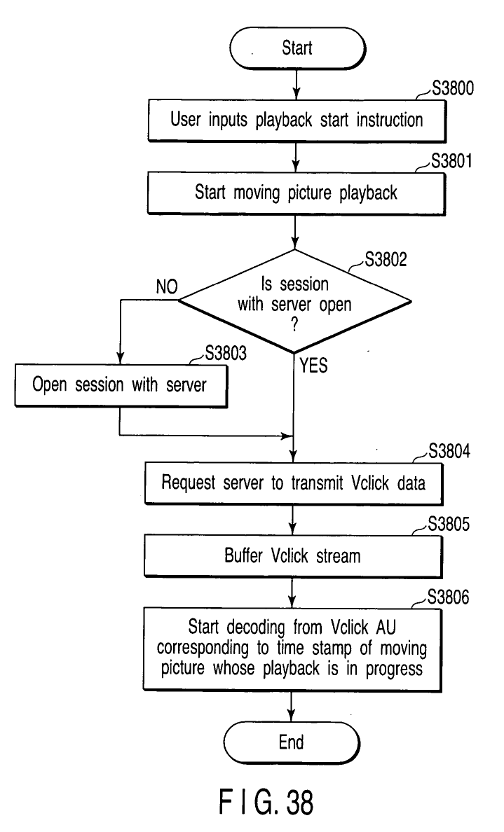

FIG. 38 is a flowchart showing the procedures of the playback start process different from those in FIG. 37. In the processes described in the flowchart of FIG. 37, the process for buffering the Vclick stream for a given size in step S3704 often takes time depending on the network status, and the processing performance of the server and client. More specifically, a long time is often required after the user issues a playback instruction until playback starts actually. In the process procedures shown in FIG. 38, if the user issues a playback start instruction in step S3800, playback of a moving picture immediately starts in step S3801. That is, upon reception of the playback start instruction from the user, interface handler 207 issues a playback start command to controller 205. In this way, the user need not wait after he or she issues a playback instruction until he or she can view a moving picture. Process steps S3802 to S3805 are the same as those in steps S3701 to S3704 in FIG. 37.

In step S3806, a process for decoding the Vclick stream in synchronism with the moving picture whose playback is in progress is executed. More specifically, upon reception of a message indicating that a given size of the Vclick stream is stored in the buffer from meta data manager 210, interface handler 207 outputs an output start command of the Vclick stream to the meta data decoder. Meta data manager 210 receives the time stamp of the moving picture whose playback is in progress from the interface handler, specifies Vclick_AU corresponding to this time stamp from data stored in the buffer, and outputs it to the meta data decoder.

In the process procedures shown in FIG. 38, the user never waits after he or she issues a playback instruction until he or she can view a moving picture. However, since the Vclick stream is not decoded immediately after the beginning of playback, no display associated with objects cannot be made, or no action is taken if the user clicks an object.

During playback of the moving picture, network manager 208 of the client receives Vclick streams which are sent in turn from the server, and stores them in buffer 209. The stored object meta data are sent to meta data decoder 217 at appropriate timings. That is, meta data manager 210 refers to the time stamp of the moving picture whose playback is in progress, which is sent from interface handler 207 to specify Vclick_AU corresponding to that time stamp from data stored in buffer 209, and sends the specified object meta data to meta data decoder 217 for respective AUs. Meta data decoder 217 decodes the received data. Note that decoder 217 may skip decoding of data for a camera angle different from that currently selected by the client. When it is known that Vclick_AU corresponding to the time stamp of the moving picture whose playback is in progress has already been loaded to meta data decoder 217, the transmission process of object meta data to the meta data decoder may be skipped.

The time stamp of the moving picture whose playback is in progress is sequentially sent from the interface handler to meta data decoder 217. The meta data decoder decodes Vclick_AU in synchronism with this time stamp, and sends required data to AV renderer 218. For example, when attribute information described in Vclick_AU instructs to display an object region, the meta data decoder generates a mask image, contour, and the like of the object region, and sends them to the AV renderer 218 in synchronism with the time stamp of the moving picture whose playback is in progress. The meta data decoder compares the time stamp of the moving picture whose playback is in progress with the lifetime of Vclick_AU to determine old object meta data which is not required and to delete that data.

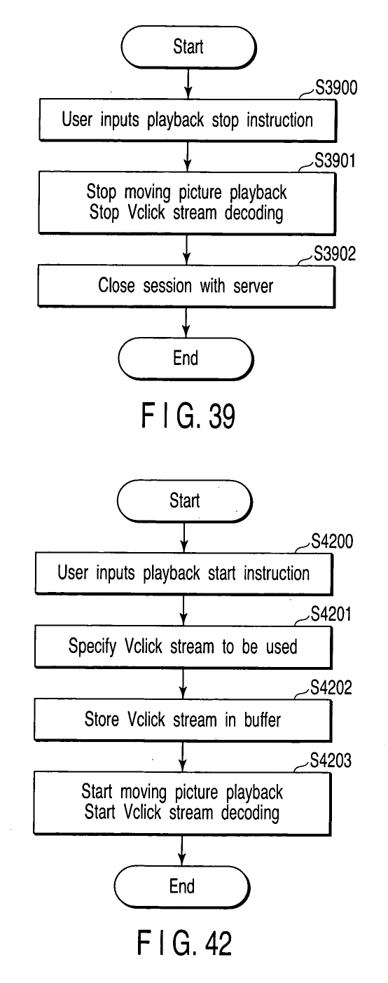

FIG. 39 is a flowchart for explaining the procedures of a playback stop process. In step S3900, the user inputs a playback stop instruction during playback of the moving picture. In step S3901, a process for stopping the moving image playback process is executed. This process is done when interface handler 207 outputs an stop command to controller 205. At the same time, the interface handler outputs, to meta data manager 210, an output stop command of object meta data to the meta data decoder.

In step S3902, a process for closing the session with the server is executed. When RTP is used, an RTSP TEARDOWN method is sent to the server, as shown in FIG. 9. Upon reception of the TEARDOWN message, the server stops data transmission to close the session, and returns a confirmation message to the client. With this process, the session ID used in the session is invalidated. On the other hand, when HTTP is used, an HTTP Close method is sent to the server to close the session.

(Random Access Procedure (Network))

The random access playback procedures when a Vclick stream is present on server 201 will be described below.

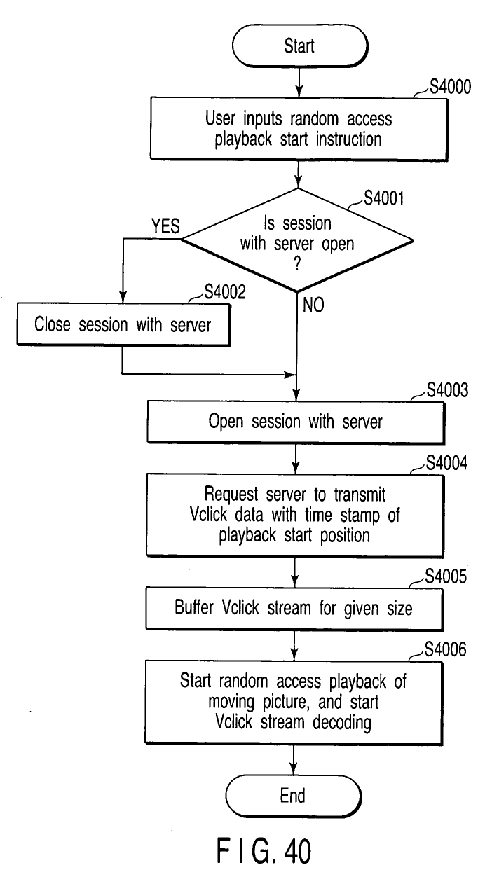

FIG. 40 is a flowchart showing the process procedures after the user issues a random access playback start instruction until playback starts. In step S4000, the user inputs a random access playback start instruction. As the input methods, a method of making the user select from a list of accessible positions such as chapters and the like, a method of making the user designate one point from a slide bar corresponding to the time stamps of a moving picture, a method of directly inputting the time stamp of a moving picture, and the like are available. The input time stamp is received by interface handler 207, which issues a moving picture playback preparation command to moving picture playback controller 205. If playback of the moving picture has already started, controller 205 issues a playback stop instruction of the moving picture whose playback is in progress, and then outputs the moving picture playback preparation command. It is checked as branch process step S4001 if a session with server 201 has already been opened. If the session has already been opened (e.g., playback of the moving image is in progress), a session close process is executed in step S4002. If the session has not been opened yet, the flow advances to step S4003 without executing the process in step S4002. In step S4003, a process for opening the session between the server and client is executed. This process is the same as that in step S3702 in FIG. 37.

In step S4004, a process for requesting the server to transmit Vclick data by designating the time stamp of the playback start position is executed while the session between the server and client is open. This process is implemented by sending an instruction from the interface handler to network manager 208, and then sending a request from network manager 208 to the server. In case of RTP, network manager 208 sends an RTSP PLAY method to the server to issue a Vclick data transmission request. At this time, manager 208 also sends the time stamp that specifies the playback start position to the server by a method using, e.g., a Range description. The server specifies a Vclick stream to be transmitted with reference to information received from the client so far and Vclick Info in the server. Furthermore, the server specifies a transmission start position in the Vclick stream using time stamp information of the playback start position included in the Vclick data transmission request and the Vclick access table stored in the server. The server then packetizes the Vclick stream and sends packets to the client by RTP.

On the other hand, in case of HTTP, network manager 208 transmits an HTTP GET method to issue a Vclick data transmission request. This request includes time stamp information of the playback start position of the moving picture. The server specifies a Vclick stream to be transmitted with reference to the Vclick information file, and also specifies the transmission start position in the Vclick stream using the Vclick access table in the server by the same method as in RTP. The server then sends the Vclick stream to the client by HTTP.

In step S4005, a process for buffering the Vclick stream sent from the server on buffer 209 is executed. This process is done to prevent the buffer from being emptied when Vclick stream transmission from the server is too late. If meta data manager 210 notifies the interface handler that the buffer has stored the sufficient Vclick stream, the flow advances to step S4006. In step S4006, the interface handler issues a moving picture playback start command to controller 205 and also issues a command to meta data manager 210 to start output of the Vclick stream to meta data decoder 217.

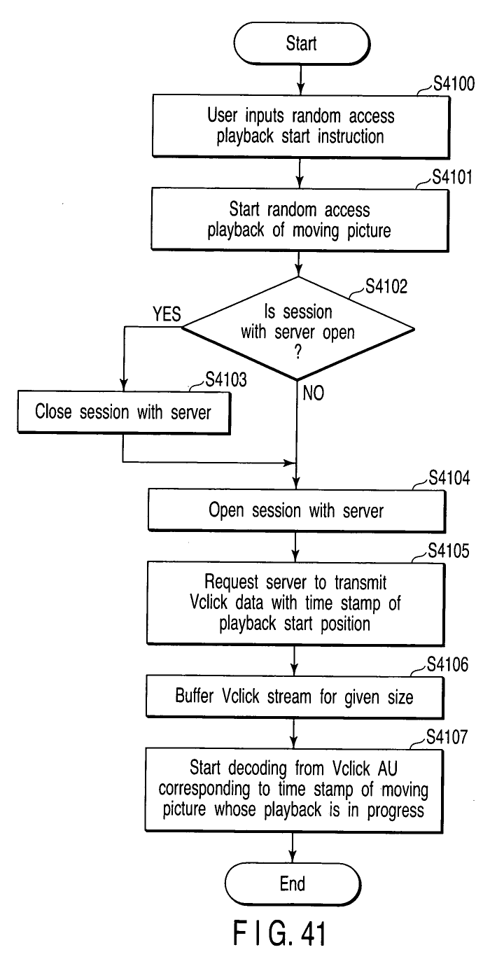

FIG. 41 is a flowchart showing the procedures of the random access playback start process different from those in FIG. 40. In the processes described in the flowchart of FIG. 40, the process for buffering the Vclick stream for a given size in step S4005 often takes time depending on the network status, and the processing performance of the server and client. More specifically, a long time is often required after the user issues a playback instruction until playback starts actually.

By contrast, in the process procedures shown in FIG. 41, if the user issues a playback start instruction in step S4100, playback of a moving picture immediately starts in step S4101. That is, upon reception of the playback start instruction from the user, interface handler 207 issues a random access playback start command to controller 205. In this way, the user need not wait after he or she issues a playback instruction until he or she can view a moving picture. Process steps S4102 to S4106 are the same as those in steps S4001 to S4005 in FIG. 40.

In step S4107, a process for decoding the Vclick stream in synchronism with the moving picture whose playback is in progress is executed. More specifically, upon reception of a message indicating that a given size of the Vclick stream is stored in the buffer from meta data manager 210, interface handler 207 outputs an output start command of the Vclick stream to the meta data decoder. Meta data manager 210 receives the time stamp of the moving picture whose playback is in progress from the interface handler, specifies Vclick_AU corresponding to this time stamp from data stored in the buffer, and outputs it to the meta data decoder.

In the process procedures shown in FIG. 41, the user never waits after he or she issues a playback instruction until he or she can view a moving picture. However, since the Vclick stream is not decoded immediately after the beginning of playback, no display associated with objects can be made, or no action is taken if the user clicks an object.

Since the processes during playback of the moving picture and moving picture playback stop process are the same as those in the normal playback process, a description thereof will be omitted.

(Playback Procedure (Local))

The procedures of a playback process when a Vclick stream is present on moving picture data recording medium 231 will be described below.

FIG. 42 is a flowchart showing the playback start process procedures after the user inputs a playback start instruction until playback starts. In step S4200, the user inputs a playback start instruction. This input is received by interface handler 207, which outputs a moving picture playback preparation command to moving picture playback controller 205. In step S4201, a process for specifying a Vclick stream to be used is executed. In this process, the interface handler refers to the Vclick information file on moving picture data recording medium 231 and specifies a Vclick stream corresponding to the moving picture to be played back designated by the user.

In step S4202, a process for storing the Vclick stream on the buffer is executed. To implement this process, interface handler 207 issues, to meta data manager 210, a command for assuring a buffer. The buffer size to be assured is determined as a size large enough to store the specified Vclick stream. Normally, a buffer initialization document that describes this size is recorded on moving picture data recording medium 231. Upon completion of assuring of the buffer, interface handler 207 issues, to controller 205, a command for reading out the specified Vclick stream and storing it in the buffer.

After the Vclick stream is stored in the buffer, a playback start process is executed in step S4203. In this process, interface handler 207 issues a moving picture playback command to moving picture playback controller 205, and simultaneously issues, to meta data manager 210, an output start command of the Vclick stream to the meta data decoder.

During playback of the moving picture, Vclick_AU read out from moving picture data recording medium 231 is stored in buffer 209. The stored Vclick stream is sent to meta data decoder 217 at an appropriate timing. That is, meta data manager 210 refers to the time stamp of the moving picture whose playback is in progress, which is sent from interface handler 207 to specify Vclick_AU corresponding to that time stamp from data stored in buffer 209, and sends the specified object meta data to meta data decoder 217 for respective AUs. Meta data decoder 217 decodes the received data. Note that decoder 217 may skip decoding of data for a camera angle different from that currently selected by the client. When it is known that Vclick_AU corresponding to the time stamp of the moving picture whose playback is in progress has already been loaded to meta data decoder 217, the transmission process of object meta data to the meta data decoder may be skipped.

The time stamp of the moving picture whose playback is in progress is sequentially sent from the interface handler to meta data decoder 217. The meta data decoder decodes Vclick_AU in synchronism with this time stamp, and sends required data to AV renderer 218. For example, when attribute information described in Vclick_AU instructs to display an object region, the meta data decoder generates a mask image, contour, and the like of the object region, and sends them to the AV renderer 218 in synchronism with the time stamp of the moving picture whose playback is in progress. The meta data decoder compares the time stamp of the moving picture whose playback is in progress with the lifetime of Vclick_AU to determine old object meta data which is not required and to delete that data.

If the user inputs a playback stop instruction during playback of the moving picture, interface handler 207 outputs a moving picture playback stop command and a Vclick stream read stop command to controller 205. With these commands, the moving picture playback process ends.

(Random Access Procedure (Network))

The random access playback procedures when a Vclick stream is present on moving picture data recording medium 231 will be described below.

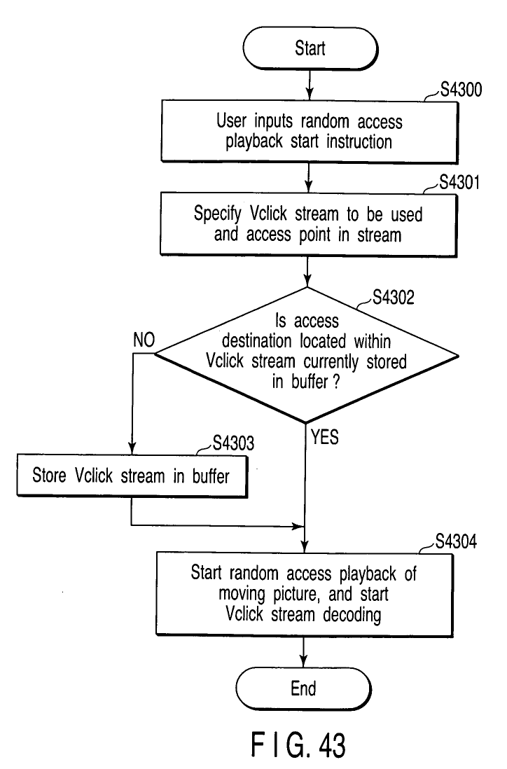

FIG. 43 is a flowchart showing the process procedures after the user issues a random access playback start instruction until playback starts. In step S4300, the user inputs a random access playback start instruction. As the input methods, a method of making the user select from a list of accessible positions such as chapters and the like, a method of making the user designate one point from a slide bar corresponding to the time stamps of a moving picture, a method of directly inputting the time stamp of a moving picture, and the like are available. The input time stamp is received by interface handler 207, which issues a moving picture playback preparation command to moving picture playback controller 205.

In step S4301, a process for specifying a Vclick stream to be used is executed. In this process, the interface handler refers to the Vclick information file on moving picture data recording medium 231 and specifies a Vclick stream corresponding to the moving picture to be played back designated by the user.

Step S4302 is a branch process that checks if the specified Vclick stream is currently loaded onto buffer 209. If the specified Vclick stream is not loaded, the flow advances to step S4304 after a process in step S4303. If the specified Vclick stream is currently loaded onto the buffer, the flow advances to step S4304 while skipping the process in step S4303. In step S4304, random access playback of the moving picture and Vclick stream decoding start. In this process, interface handler 207 issues a moving picture random access playback command to moving picture playback controller 205, and simultaneously outputs, to meta data manager 210, a command to start output of the Vclick stream to the meta data decoder. After that, the Vclick stream decoding process is executed in synchronism with playback of the moving picture. Since the processes during playback of the moving picture and moving picture playback stop process are the same as those in the normal playback process, a description thereof will be omitted.

(Procedure from Clicking Until Related Information Display)

The operation of the client executed when the user has clicked a position within an object region using a pointing device such as a mouse or the like will be described below. When the user has clicked a given position, the clicked coordinate position on the moving picture is input to interface handler 207. The interface handler sends the time stamp and coordinate position of the moving picture upon clicking to meta data decoder 217. The meta data decoder executes a process for specifying an object designated by the user on the basis of the time stamp and coordinate position.

Since the meta data decoder decodes a Vclick stream in synchronism with playback of the moving picture, and has already generated the region of the object at the time stamp upon clicking, it can easily implement this process. When a plurality of object regions are present at the clicked coordinate position, the frontmost object is specified with reference to layer information included in Vclick_AU.

After the object designated by the user is specified, meta data decoder 217 sends an action description (a script that designates an action) described in object attribute information 403 to script interpreter 212. Upon reception of the action description, the script interpreter interprets the action contents and executes an action. For example, the script interpreter displays a designated HTML file or begins to play back a designated moving picture. These HTML file and moving picture data may be recorded on client 200, may be sent from server 201 via the network, or may be present on another server on the network.

(Detailed Data Structure)

Configuration examples of practical data structures will be explained below. FIG. 11 shows an example of the data structure of Vclick stream 506.

The meanings of data elements are:

vcs_start_code indicates the start of a Vclick stream;

data_length designates the data length of a field after data_length in this Vclick stream using bytes as a unit; and

data_bytes corresponds to a data field of Vclick_AU. This field includes header 507 of the Vclick stream at the head position, and one or a plurality of Vclick_AUs or NULL_AUs (to be described later) follow.

FIG. 12 shows an example of the data structure of header 507 of the Vclick stream. The meanings of data elements are:

vcs_header_code indicates the start of the header of the Vclick stream;

data_length designates the data length of a field after data_length in the header of the Vclick stream using bytes as a unit;

vclick_version designates the version of the format. This value assumes 01h in this specification; and

bit_rate designates a maximum bit rate of this Vclick stream.

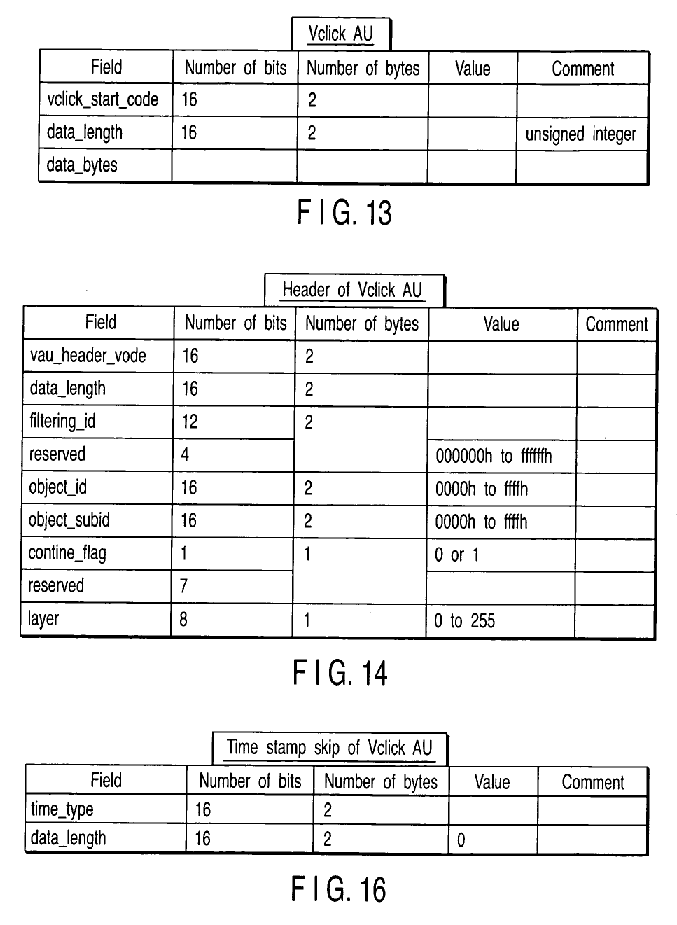

FIG. 13 shows an example of the data structure of Vclick_AU. The meanings of data elements are:

vclick_start_code indicates the start of each Vclick_AU;

data_length designates the data length of a field after data_length in this Vclick_AU using bytes as a unit; and

data_bytes corresponds a data field of Vclick_AU. This field includes header 401, time stamp 402, object attribute information 403, and object region information 400.

FIG. 14 shows an example of the data structure of header 401 of Vclick_AU. The meanings of data elements are:

Vclick_header_code indicates the start of the header of each Vclick_AU;

data_length designates the data length of a field after data_length in the header of this Vclick_AU using bytes as a unit;

filtering id is an ID used to identify Vclick_AU. This data is used to determine Vclick_AU to be decoded on the basis of the attributes of the client and this ID;

object_id is an identification number of an object described in Vclick data. When the same object_id value is used in two Vclick_AUs, they are data for a semantically identical object;

object_subid represents semantic continuity of objects. When two Vclick_AUs include the same object_id and object_subid values, they mean continuous objects;

continue_flag is a flag. If this flag is “1”, an object region described in this Vclick_AU is continuous to that described in the next Vclick_AU having the same object_id. Otherwise, this flag is “0”; and

layer represents a layer value of an object. As the layer value is larger, this means that an object is located on the front side on the screen.

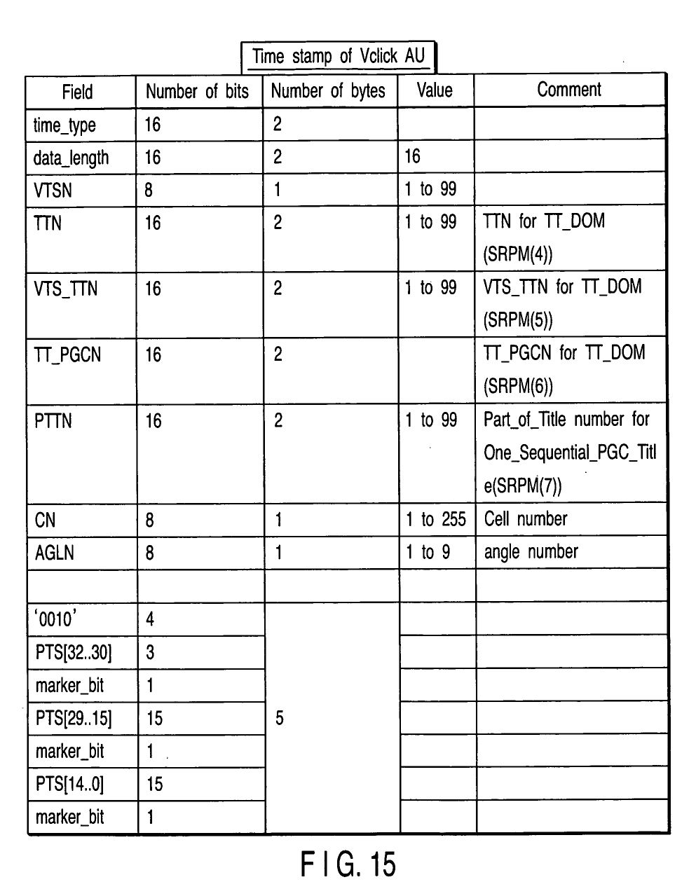

FIG. 15 shows an example of the data structure of time stamp 402 of Vclick_AU. This example assumes a case wherein a DVD is used as moving picture data recording medium 231. Using the following time stamp, an arbitrary time of a moving picture on the DVD can be designated, and synchronization between the moving picture and Vclick data can be attained. The meanings of data elements are:

time_type indicates the start of a DVD time stamp;

data_length designates the data length of a field after data_length in this time stamp using bytes as a unit;

VTSN indicates a VTS (video title set) number of DVD video;

TTN indicates a title number in the title domain of DVD video. This number corresponds to a value stored in system parameter SPRM(4) of a DVD player;

VTS_TTN indicates a VTS title number in the title domain of DVD video. This number corresponds to a value stored in system parameter SPRM(5) of the DVD player;

TT_PGCN indicates a title PGC (program chain) number in the title domain of DVD video. This number corresponds to a value stored in system parameter SPRM(6) of the DVD player;

PTTN indicates a part-of-title (Part_of_Title) number of DVD video. This number corresponds to a value stored in system parameter SPRM(7) of the DVD player;

CN indicates a cell number of DVD video;

AGLN indicates an angle number of DVD video; and

PTS[s . . . e] indicates data of s-th to e-th bits of the display time stamp of DVD video.

FIG. 16 shows an example of the data structure of time stamp skip of Vclick_AU. When the time stamp skip is described in Vclick_AU in place of a time stamp, this means that the time stamp of this Vclick_AU is the same as that of the immediately preceding Vclick_AU.

The meanings of data elements are:

time_type indicates the start of the time stamp skip; and

data_length designates the data length of a field after data_length of this time stamp skip using bytes as a unit. However, this value always assumes “0” since the time stamp skip include only time_type and data_length.

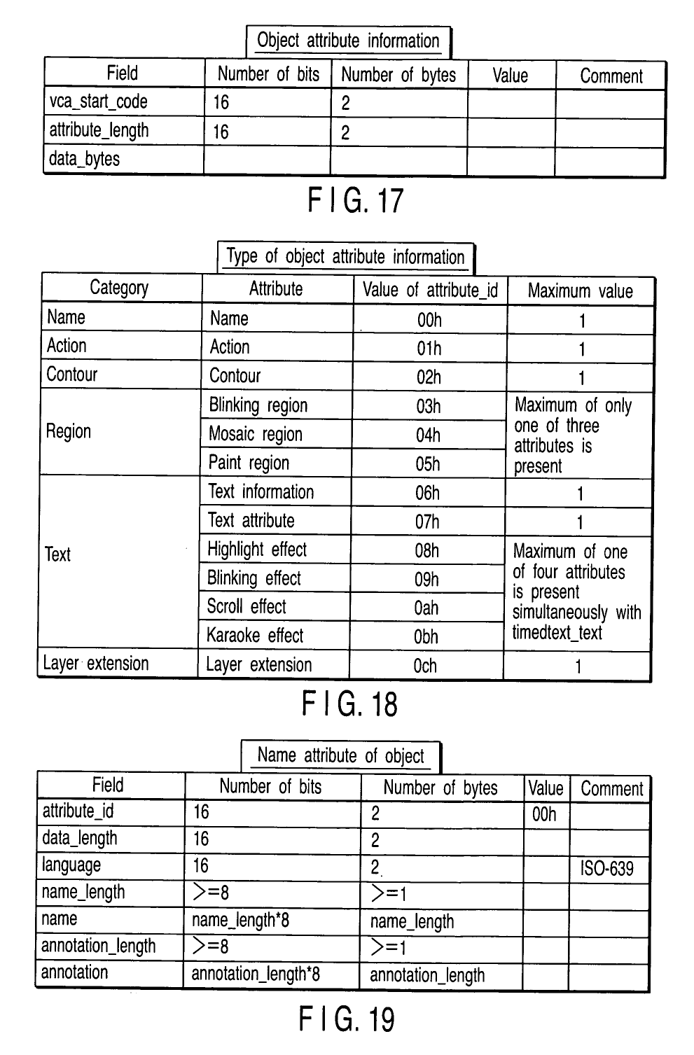

FIG. 17 shows an example of the data structure of object attribute information 403 of Vclick_AU. The meanings of data elements are:

vca_start_code indicates the start of the object attribute information of each Vclick_AU;

data_length designates the data length of a field after data_length in this object attribute information using bytes as a unit; and

data_bytes corresponds to a data field of the object attribute information. This field describes one or a plurality of attributes.

Details of attribute information described in object attribute information 403 will be described below. FIG. 18 shows a list of the types of attributes that can be described in object attribute information 403. A column “maximum value” describes an example of the maximum number of data that can be described in one object meta data AU for each attribute.

attribute_id is an ID included in each attribute data, and is data used to identify the type of attribute. A name attribute is information used to specify the object name. An action attribute describes an action to be taken upon clicking an object region in a moving picture. A contour attribute indicates a display method of an object contour. A blinking region attribute specifies a blinking color upon blinking an object region. A mosaic region attribute describes a mosaic conversion method upon applying mosaic conversion to an object region, and displaying the converted region. A paint region attribute specifies a color upon painting and displaying an object region.

Attributes which belong to a text category define attributes associated with characters to be displayed when characters are to be displayed on a moving picture. Text information describes text to be displayed. A text attribute specifies attributes such as a color, font, and the like of text to be displayed. A highlight effect attribute specifies a highlight display method of characters upon highlighting partial or whole text. A blinking effect attribute specifies a blinking display method of characters upon blinking partial or whole text. A scroll effect attribute describes a scroll direction and speed upon scrolling text to be displayed. A karaoke effect attribute specifies a change timing and position of characters upon changing a text color sequentially.

Finally, a layer extension attribute is used to define a change timing and value of a change in layer value when the layer value of an object changes in Vclick_AU. The data structures of the aforementioned attributes will be individually explained below.

FIG. 19 shows an example of the data structure of the name attribute of an object. The meanings of data elements are:

attribute_id designates a type of attribute data. The name attribute has attribute_id=00h;

data_length indicates the data length after data_length of the name attribute data using bytes as a unit;

language specifies a language used to describe the following elements (name and annotation). A language is designated using ISO-639 “code for the representation of names of languages”;

name_length designates the data length of a name element using bytes as a unit;

name is a character string, which represents the name of an object described in this Vclick_AU;

annotation_length represents the data length of an annotation element using bytes as a unit; and

annotation is a character string, which represents an annotation associated with an object described in this Vclick_AU.

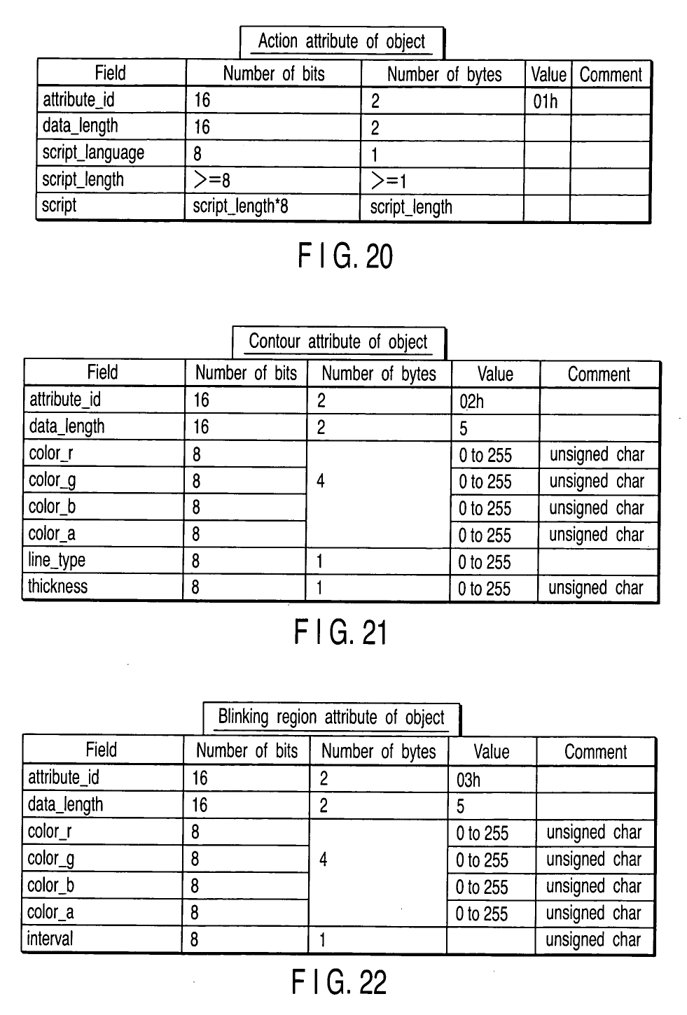

FIG. 20 shows an example of the data structure of the action attribute of an object. The meanings of data elements are:

attribute_id designates a type of attribute data. The action attribute has attribute_id=01h;

data_length indicates the data length of a field after data_length of the action attribute data using bytes as a unit;

script_language specifies a type of script language described in a script element;

script_length represents the data length of the script element using bytes as a unit; and

script is a character string which describes an action to be executed using the script language designated by script_language when the user designates an object described in this Vclick_AU.

FIG. 21 shows an example of the data structure of the contour attribute of an object. The meanings of data elements are:

attribute_id designates a type of attribute data. The contour attribute has attribute_id=02h;

data_length indicates the data length of a field after data_length of the contour attribute data using bytes as a unit;

color_r, color_g, color_b, and color_a designate a display color of the contour of an object described in this object meta data AU;

color_r, color_g, and color_b designate red, green, and blue values in RGB expression of the color.

color_a indicates transparency;

line_type designates the type of contour (solid line, broken line, or the like) of an object described in this Vclick_AU; and

thickness designates the thickness of the contour of an object described in this Vclick_AU using points as a unit.

FIG. 22 shows an example of the data structure of the blinking region attribute of an object.

The meanings of data elements are:

attribute_id designates a type of attribute data. The blinking region attribute data has attribute_id=03h;

data_length indicates the data length of a field after data_length of the blinking region attribute data using bytes as a unit;

color_r, color_g, color_b, and color_a designate a display color of a region of an object described in this Vclick_AU. color_r, color_g, and color_b designate red, green, and blue values in RGB expression of the color. color_a indicates transparency. Blinking of an object region is realized by alternately displaying the color designated in the paint region attribute and that designated in this attribute; and

interval designates the blinking time interval.

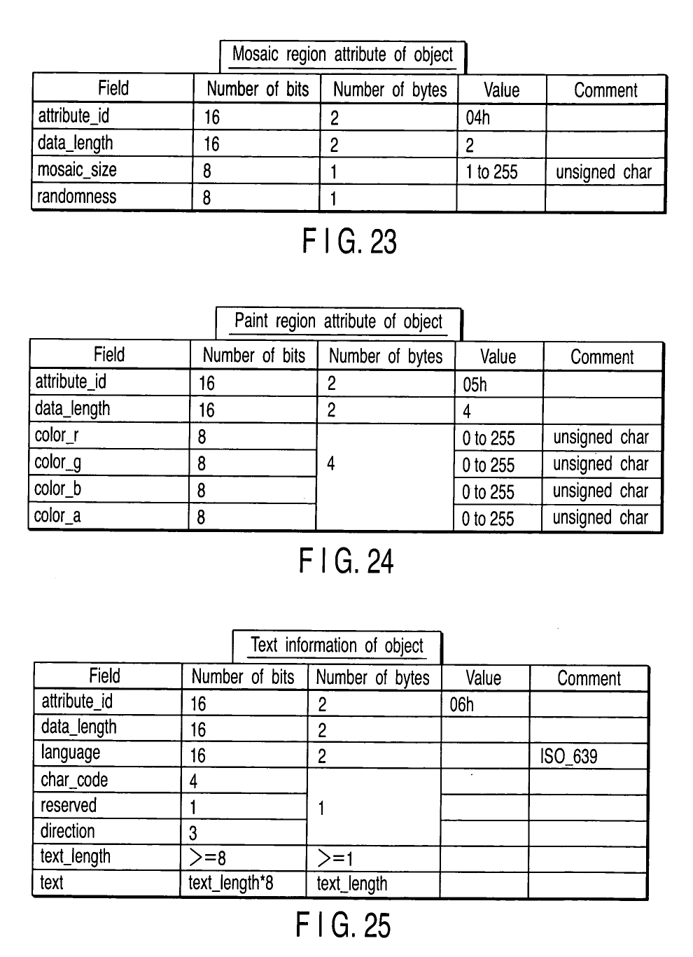

FIG. 23 shows an example of the data structure of the mosaic region attribute of an object. The meanings of data elements are:

attribute_id designates a type of attribute data. The mosaic region attribute data has attribute_id=04h;

data_length indicates the data length of a field after data_length of the mosaic region attribute data using bytes as a unit;

mosaic_size designates the size of a mosaic block using pixels as a unit; and

randomness represents a degree of randomness upon replacing mosaic-converted block positions.

FIG. 24 shows an example of the data structure of the paint region attribute of an object. The meanings of data elements are:

attribute_id designates a type of attribute data. The paint region attribute data has attribute_id=05h;

data_length indicates the data length of a field after data_length of the paint region attribute data using bytes as a unit; and

color_r, color_g, color_b, and color_a designate a display color of a region of an object described in this Vclick_AU. color_r, color_g, and color_b designate red, green, and blue values in RGB expression of the color. color_a indicates transparency.

FIG. 25 shows an example of the data structure of the text information of an object. The meanings of data elements are:

attribute_id designates a type of attribute data. The text information of an object has attribute_id=06h;

data_length indicates the data length of a field after data_length of the text information of an object using bytes as a unit;

language indicates a language of described text. A method of designating a language can use ISO-639 “code for the representation of names of languages”;

char_code specifies a code type of text. For example, UTF-8, UTF-16, ASCII, Shift JIS, and the like are used to designate the code type;

direction specifies a left, right, up, or down direction as a direction upon arranging characters. For example, in case of English or French, characters are normally arranged in the left direction. On the other hand, in case of Arabic, characters are arranged in the right direction. In case of Japanese, characters are arranged in either the left or down direction. However, an arrangement direction other than that determined for each language may be designated. Also, an oblique direction may be designated;

text_length designates the length of timed text using bytes as a unit; and

text is a character string, which is text described using the character code designated by char_code.

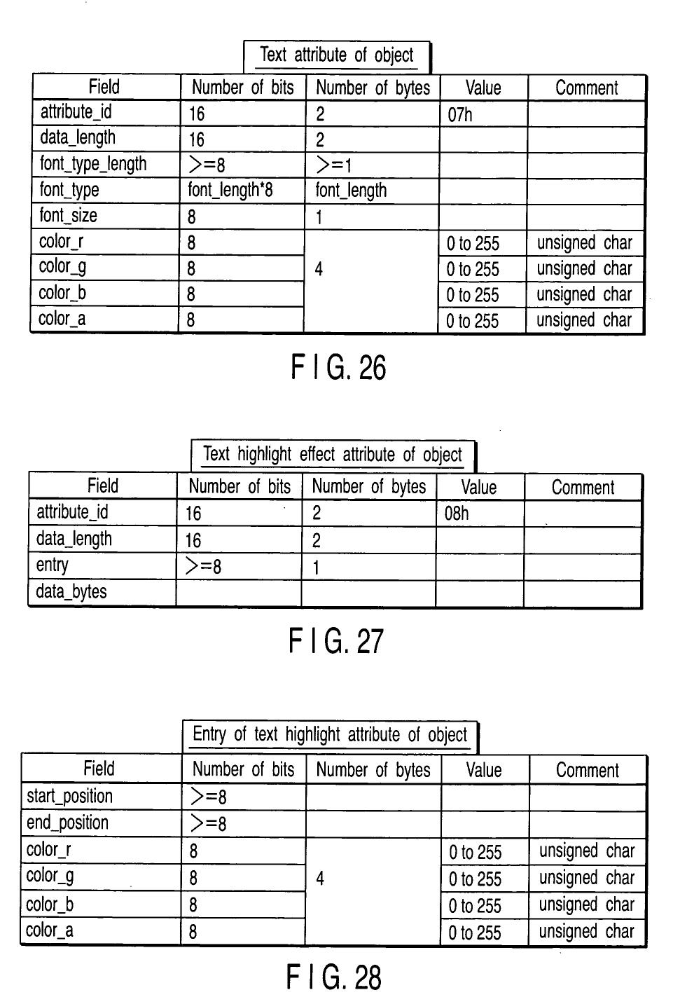

FIG. 26 shows an example of the text attribute of an object. The meanings of data elements are:

attribute_id designates a type of attribute data. The text attribute of an object has attribute_id=07h;

data_length indicates the data length of a field after data_length of the text attribute of an object using bytes as a unit;

font_length designates the description length o f font using bytes as a unit;

font is a character string, which designates font used upon displaying text; and

color_r, color_g, color_b, and color_a designate a display color of text. color_r, color_g, and color_b designate red, green, and blue values in RGB expression of the color. color_a indicates transparency.

FIG. 27 shows an example of the text highlight attribute of an object. The meanings of data elements are:

attribute_id designates a type of attribute data. The text highlight effect attribute of an object has attribute_id=08h;

data_length indicates the data length of a field after data_length of the text highlight effect attribute of an object using bytes as a unit;

entry indicates the number of “highlight_effect_entry”s in this text highlight effect attribute data; and

data_bytes includes “highlight_effect_entry”s as many as entry.

The specification of highlight_effect entry is as follows.

FIG. 28 shows an example of an entry of the text highlight effect attribute of an object. The meanings of data elements are:

start_position designates the start position of a character to be highlighted using the number of characters from the head to that character;

end_position designates the end position of a character to be highlighted using the number of characters from the head to that character; and

color_r, color_g, color_b, and color_a designate a display color of the highlighted characters.

color_r, color_g, and color_b designate red, green, and blue values in RGB expression of the color. color_a indicates transparency.

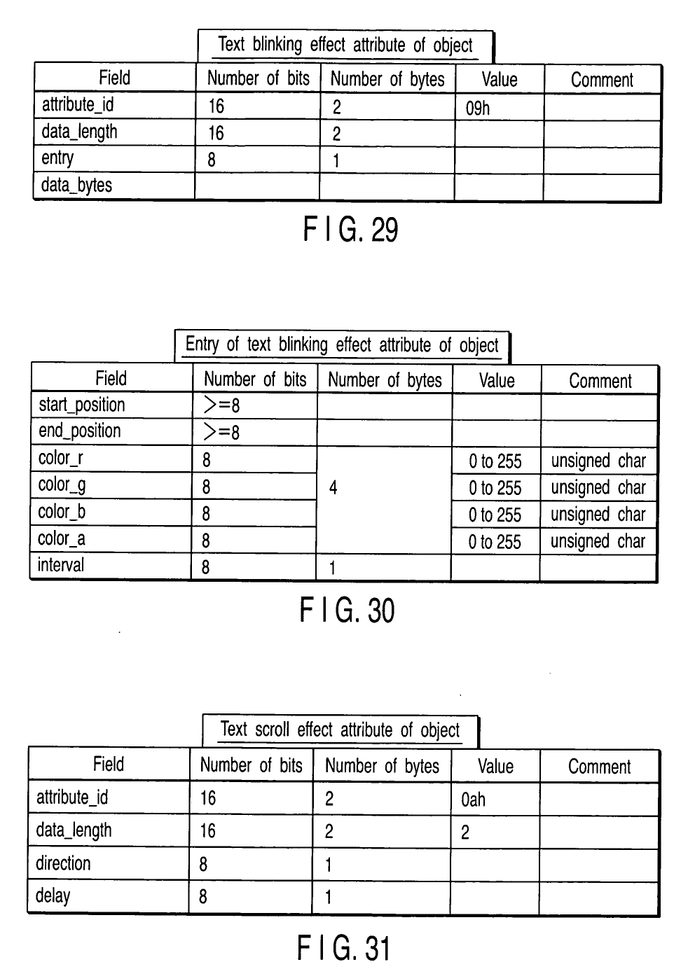

FIG. 29 shows an example of the data structure of the text blinking effect attribute of an object.

The meanings of data elements are:

attribute_id designates a type of attribute data. The text blinking effect attribute data of an object has attribute_id=09h;

data_length indicates the data length of a field after data_length of the text blinking effect attribute data using bytes as a unit;

entry indicates the number of “blink_effect_entry”s in this text blinking effect attribute data; and

data_bytes includes “blink_effect_entry”s as many as entry.

The specification of blink_effect_entry is as follows.

FIG. 30 shows an example of an entry of the text blinking effect attribute of an object. The meanings of data elements are:

start_position designates the start position of a character to be blinked using the number of characters from the head to that character;

end_position designates the end position of a character to be blinked using the number of characters from the head to that character;

color_r, color_g, color_-b, and color_a designate a display color of the blinking characters. color_r, color_g, and color_b designate red, green, and blue values in RGB expression of the color. color_a indicates transparency. Note that characters are blinked by alternately displaying the color designated by this entry and the color designated by the text attribute; and

interval designates the blinking time interval.

FIG. 31 shows an example of the data structure of the text scroll effect attribute of an object.

The meanings of data elements are:

attribute_id designates a type of attribute data. The text scroll effect attribute data of an object has attribute_id=Oah;

data_length indicates the data length of a field after data_length of the text scroll effect attribute data using bytes as a unit;

direction designates a direction to scroll characters. For example, 0 indicates a direction from right to left, 1 indicates a direction from left to right, 2 indicates a direction from up to down, and 3 indicates a direction from down to up; and

delay designates a scroll speed by a time difference from when the first character to be displayed appears until the last character appears.

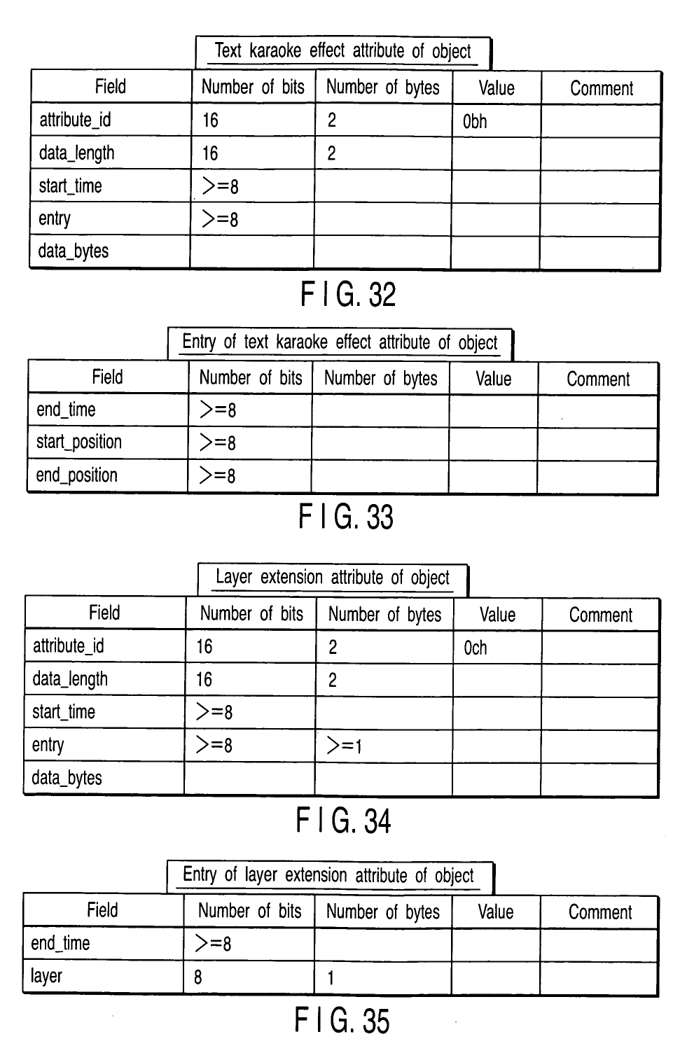

FIG. 32 shows an example of the data structure of the text karaoke effect attribute of an object.

The meanings of data elements are:

attribute_id designates a type of attribute data. The text karaoke effect attribute data of an object has attribute_id=0bh;

data_length indicates the data length of a field after data_length of the text karaoke effect attribute data using bytes as a unit;

start_time designates a change start time of a text color of a character string designated by first karaoke_effect_entry included in data_bytes of this attribute data;

entry indicates the number of “karaoke_effect_entry”s in this text karaoke effect attribute data; and

data_bytes includes “karaoke_effect_entry”s as many as entry.

The specification of karaoke_effect_entry is as follows.

FIG. 33 shows an example of the data structure of an entry of the text karaoke effect attribute of an object. The meanings of data elements are:

end_time indicates a change end time of the text color of a character string designated by this entry. If another entry follows this entry, end_time also indicates a change start time of the text color of a character string designated by the next entry;

start_position designates the start position of a character whose text color is to be changed using the number of characters from the head to that character; and

end_position designates the end position of a character whose text color is to be changed using the number of characters from the head to that character.

FIG. 34 shows an example of the data structure of the layer extension attribute of an object.

The meanings of data elements are:

attribute_id designates a type of attribute data. The layer extension attribute data of an object has attribute_id=Och;

data_length indicates the data length of a field after data_length of the layer extension attribute data using bytes as a unit;

start_time designates a start time at which the layer value designated by the first layer_extension_entry included in data_bytes of this attribute data is enabled;

entry designates the number of “layer_extension_entry”s included in this layer extension attribute data; and

data_bytes includes “layer_extension_entry”s as many as entry.

The specification of layer_extension_entry will be described below.

FIG. 35 shows an example of the data structure of an entry of the layer extension attribute of an object.

The meanings of data elements are:

end_time designates a time at which the layer value designated by this layer_extension_entry is disabled. If another entry follows this entry, end_time also indicates a start time at which the layer value designated by the next entry is enabled; and

layer designates the layer value of an object.

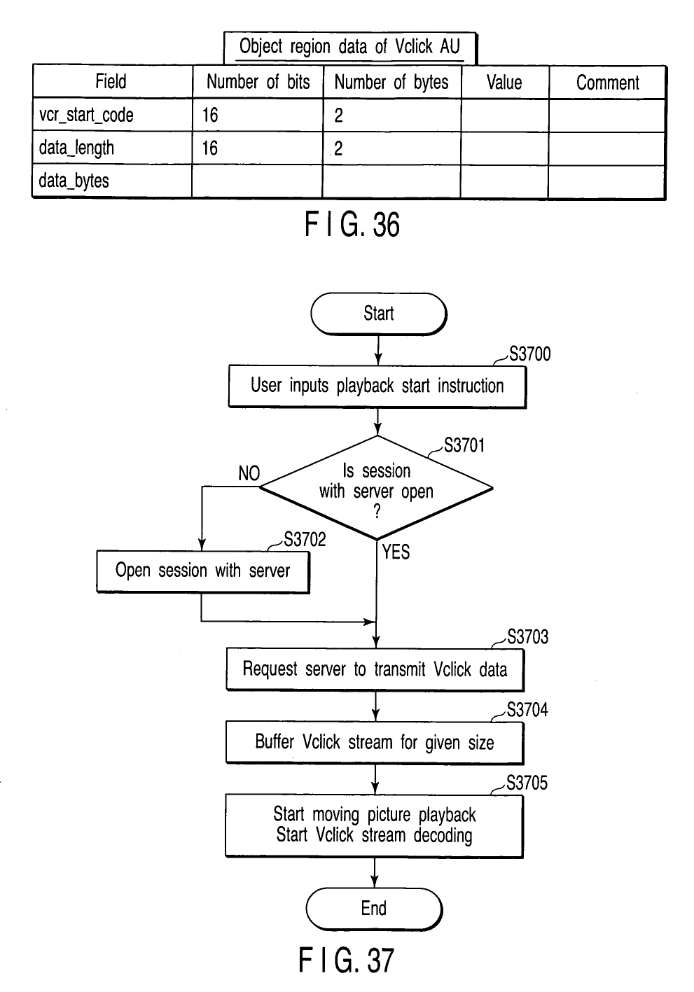

FIG. 36 shows an example of object region data 400 of object meta data. The meanings of data elements are:

vcr_start_code means the start of object region data;

data_length designates the data length of a field after data_length of the object region data using bytes as a unit; and

data_bytes is a data field that describes an object region. The object region can be described using, e.g., the binary format of MPEG-7 SpatioTemporalLocator.

(Application Image)

FIG. 76 shows a display example, on a screen, of an application (moving picture hypermedia), which is different from FIG. 1, and is implemented using object meta data of the present invention and a moving picture together. In FIG. 1, a moving picture and associated information are displayed on independent windows. However, in FIG. 76, one window A01 displays moving picture A02 and associated information A03. As associated information, not only text but still picture A04 and a moving picture different from A02 can be displayed.

(Lifetime Designation Method of Vclick_AU using Duration Data)

FIG. 77 shows an example of the data structure of Vclick_AU, which is different from FIG. 4. The difference from FIG. 4 is that data used to specify the lifetime of Vclick_AU is a combination of time stamp B01 and endurance or duration B02 in place of the time stamp alone. Time stamp B01 is the start time of the lifetime of Vclick_AU, and duration B02 is a duration from the start time to the end time of the lifetime of Vclick_AU. Note that time_type is an ID used to specify that data shown in FIG. 79 means a duration, and duration is a duration. duration indicates a duration using a predetermined unit (e.g., 1 msec, 0.1 sec, or the like).

An advantage offered when the duration is also described as data used to specify Vclick_AU lies in that the duration of Vclick_AU can be detected by checking only Vclick_AU to be processed. When valid Vclick_AUs with a given time stamp are to be found, it is checked without checking other Vclick_AU data if the Vclick_AU of interest is to be found. However, the data size increases by duration B02 compared to FIG. 4.

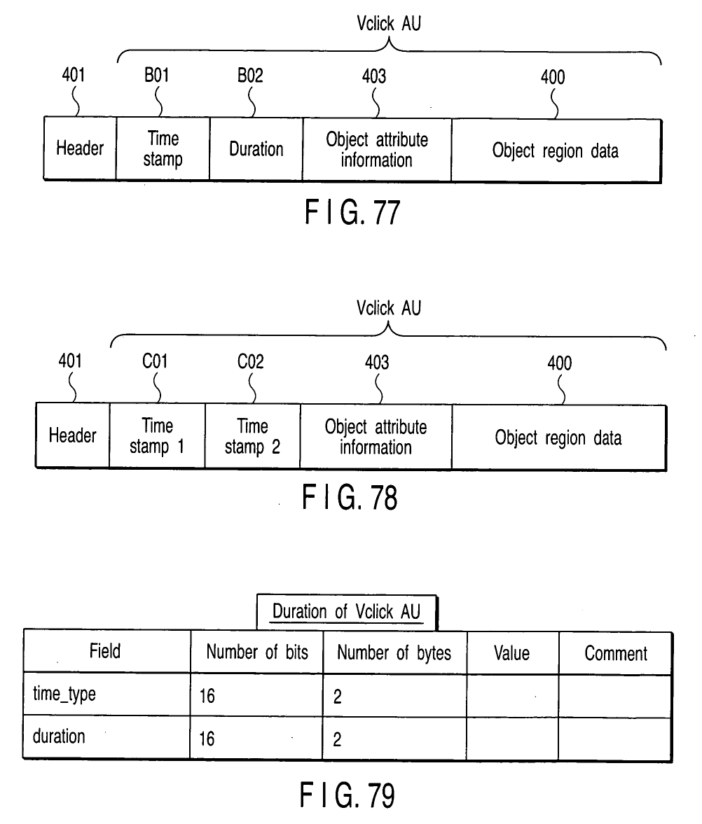

FIG. 78 shows an example of the data structure of Vclick_AU, which is different from FIG. 77. In this example, as data for specifying the lifetime of Vclick_AU, time stamp C01 that specifies the start time of the lifetime of Vclick_AU and time stamp C02 that specifies the end time are used. The advantage offered upon using this data structure is the same as that upon using the data structure of FIG. 77.

Note that the present invention is not limited to the aforementioned embodiments, and various modifications of constituent elements may be made without departing from the scope of the invention when it is practiced. For example, the present invention can be applied not only to widespread DVD-ROM video, but also to DVD-VR (video recorder) whose demand is increasing rapidly in recent years and which allows recording/playback. Furthermore, the present invention can be applied to a playback or recording/playback system of next-generation HD-DVD, which will be prevalent soon.

Various inventions can be formed by appropriately combining a plurality of required constituent elements disclosed in the aforementioned embodiment. For example, some required constituent elements are deleted from all the required constituent elements disclosed in the embodiments. Also, required constituent elements associated with different embodiments may be appropriately combined.

(Use of Object_Subid)

The Vclick data explained above can be used to search for an object which appears in a moving picture. For example, a name or piece of information of an object is described in text in name or annotation included in the name attribute of the object. Therefore, keyword search is performed for these items of data, thereby searching for a desired object.

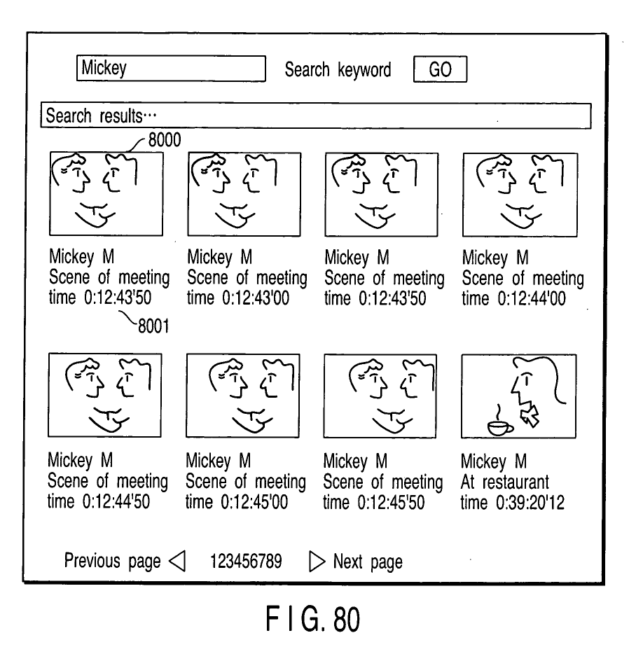

FIG. 80 is a screen example where search results using the Vclick data are displayed. In this search, all the Vclick AUs including an input keyword are to be searched for. An image (8000) is a thumbnail and is a image of a time corresponding to a time stamp of the searched Vclick AU. Explanations (8001) below the thumbnail are a name and annotation included in the name attribute of the object in the searched Vclick AU, and a time stamp thereof. In this example, a moving picture can be played back from the scene by clicking the thumbnail or the explanations below the thumbnail.

When all the Vclick AUs are listed up as the search results as shown in FIG. 80, there is a problem that there are too many displayed search results. For example, it is assumed that a moving picture where one character appears in 10 scenes is searched. Further, it is assumed that each appearance scene is divided into 15 Vclick AUs on average and that 150 Vclick AUs in total for the character are included. All the object_id's of these Vclick AUs have the same value. Therefore, when a search is performed by a keyword corresponding to this character, 150 Vclick AUs are hit. However, many of them are the appearances in the same scene, and thus, even when the list of thumbnails as shown in FIG. 80 or the searched scenes are played back, almost all the scenes are similar. Further, since the number of hits of search is increased, it is difficult to search for a desired scene from the search results.

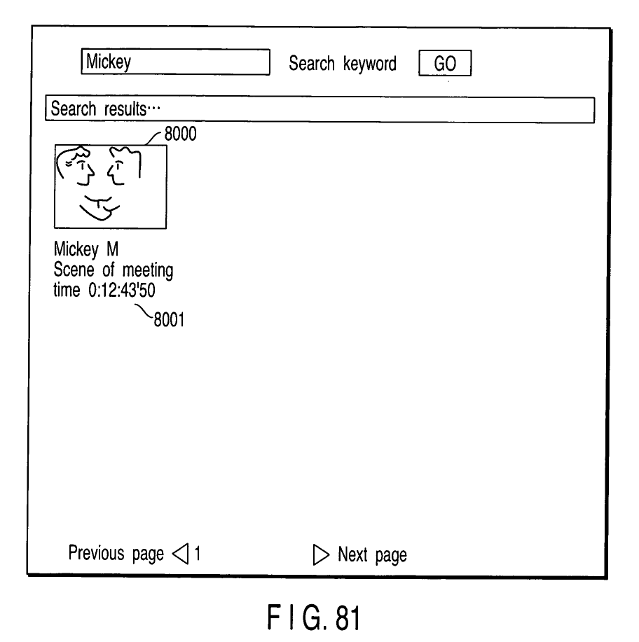

The above problem that many similar search results are displayed is solved by using an object_id included in the Vclick AU header. In other words, the Vclick AU having the same object_id may be omitted from the search results. FIG. 81 is an example where the search result is displayed in this manner. However, in this method, it is possible to obtain only one search result for one object as can be seen from FIG. 81. In this case, it is not possible to make accesses to the respective scenes when an object to be searched for appears on several scenes.

In order to solve the problem that when all the keyword search results for all the Vclick AUs are displayed, many similar search results are displayed, and to avoid a phenomenon that when the search results of the Vclick AUs having the common object_id are omitted, the search results are too few, search is performed by using not only the object_id but also the object_subid included in the Vclick AU header. The method thereof will be described below.

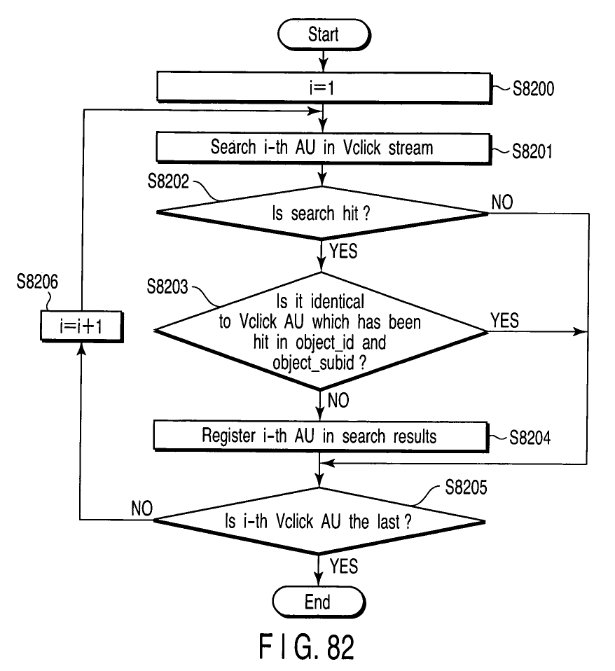

FIG. 82 is an example of a flow for explaining a keyword search processing of the Vclick AU using the object_subid. In step S8200, 0 is substituted in “i” as an initial value. Next, in step S8201, keyword search is performed for the i-th Vclick AU in a Vclick stream. In other words, it is checked whether the input keyword is included in the name or annotation which is included in the name attribute of the Vclick AU object. At this time, high level matching may be performed, such as checking whether not only the keyword but also synonyms of the keyword are included or not. Further, not only input by simple keyword but also input by natural language may be performed.

Step S8202 is a selection processing, where it is checked whether or not the i-th Vclick AU is hit as a result of the search processing in step S8201. When it is hit, the processing advances to step S8203. When it is not hit, the processing proceeds to step S8205.

Step S8203 is a branch processing, where it is checked whether or not the object_id and the object_subid of the i-th Vclick AU are identical to the object_id and the object_subid of the hit Vclick AU, respectively. When both the object_id and the object_subid are identical, respectively, the processing proceeds to step S8204, where the i-th Vclick AU is registered in the search results. Otherwise, registration is not performed and the processing proceeds to step S8205.

In step S8205, a determination is made as to whether or not the i-th Vclick AU to be processed is the last of the Vclick stream. When it is the last, the processing is terminated, and when it is not the last, the variable “i” is updated in step S8206 and the processings from step S8201 are repeated.

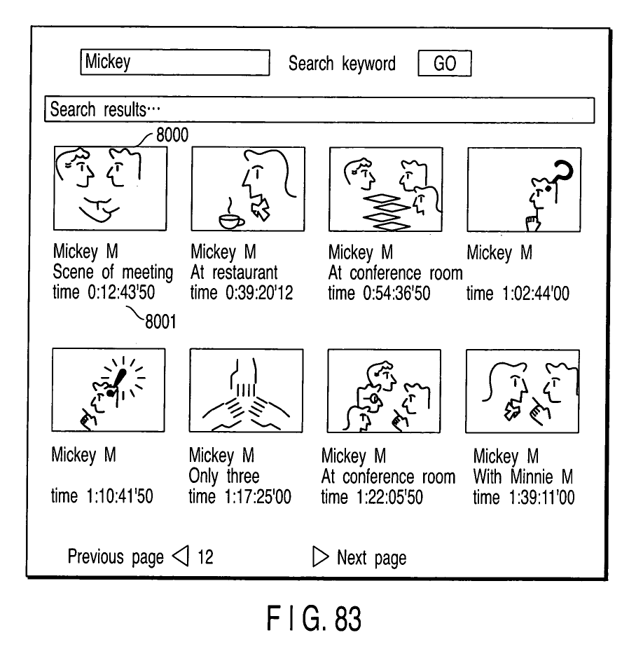

While the object_id having the same value is given to the same object in the Vclick AU, the object_subid having the same value is given thereto only when the scene is also identical. Therefore, when the processing in FIG. 82 is performed, one Vclick AU for each scene is output as the search result. FIG. 83 is a screen display example of the results of keyword search of the Vclick AUs using the object_subid. As can be seen from FIG. 83, since it is possible to obtain only one search result for each scene according to this method, similar scenes are not displayed unlike when a list of searched objects is displayed or an appearance scene is played back. Further, the number of hits of search becomes less, thereby easily searching a desired scene.

(Use of Continue Flag)

When RTP is used as a communication protocol, part of the data to be delivered from a server to a client may be missing since data retransmission is not performed in a normal mode. Even when HTTP, which a highly reliable communication protocol, is used, a delay occurs during correctly delivering the data from the server to the client if a situation of the communication path is bad, and the data may not be in time for the processing at the client. This may cause part of the Vclick AUs to be missing at the client side. When the Vclick AU is missing, there occurs an influence that a desired action does not occur even when an object is designated or a contour appears or disappears when the contour of the object is displayed. Here, there will be described a method of using continue flag to reduce an influence of partial absence of the Vclick AUs.

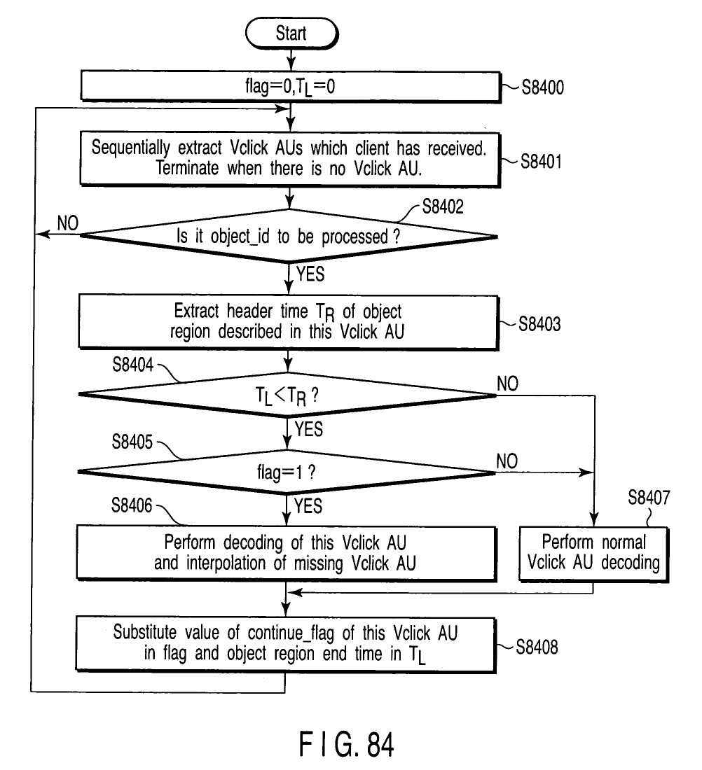

FIG. 84 is a flow chart for explaining a flow of a processing where when Vclick AUs in a Vclick stream are sequentially input, data of an object corresponding to a certain object_id value is processed. In this processing, the missing Vclick AU is initially determined, and then a determination is made as to whether or not the interpolation processing for the missing data is performed.

First, in step S8400, 0 is substituted in two variables “flag” and “T_{R}” as an initialization processing. Next, in step S8401, the Vclick AUs which the client has received are sequentially extracted and the processings subsequent to this step are performed. When a new Vclick AU is not present, the processing is terminated.

In step S8402, the object_id of the Vclick AU to be processed is extracted, and a determination is made as to whether or not it is identical to a certain object_id to be processed. When it is identical thereto, in step S8403, there is performed a processing of extracting a header time T_{R} of the object region described in the object region data 400 included in this Vclick AU. When the object_id is different, the processing returns to step S8401.

In step S8404, a determination is made as to whether or not T_{R} is larger than T_{L}. T_{L} is an object region end time of the Vclick AU having the same object_id processed immediately before the Vclick AU which is currently being processed. When T_{R} is larger than T_{L}, it is determined that there is no missing Vclick AU, and the normal Vclick AU decode processing (step S8407) is performed. On the other hand, when T_{R} is T_{L} or less, the processing advances to step S8405.

In step S8405, the value of the variable “flag” is checked, and when it is 1, it is determined that the Vclick AU is missing, and the processing in step S8406 is performed. When the value of “flag” is 0, it is determined that there is no missing Vclick AU, and the processing in step S8407 is performed.

Step S8408 is a variable update processing, where the value of the continue flag of the Vclick AU is substituted in the variable “flag” and the object region end time described in this Vclick AU is substituted in T_{R}, and the processing returns to step S8401.

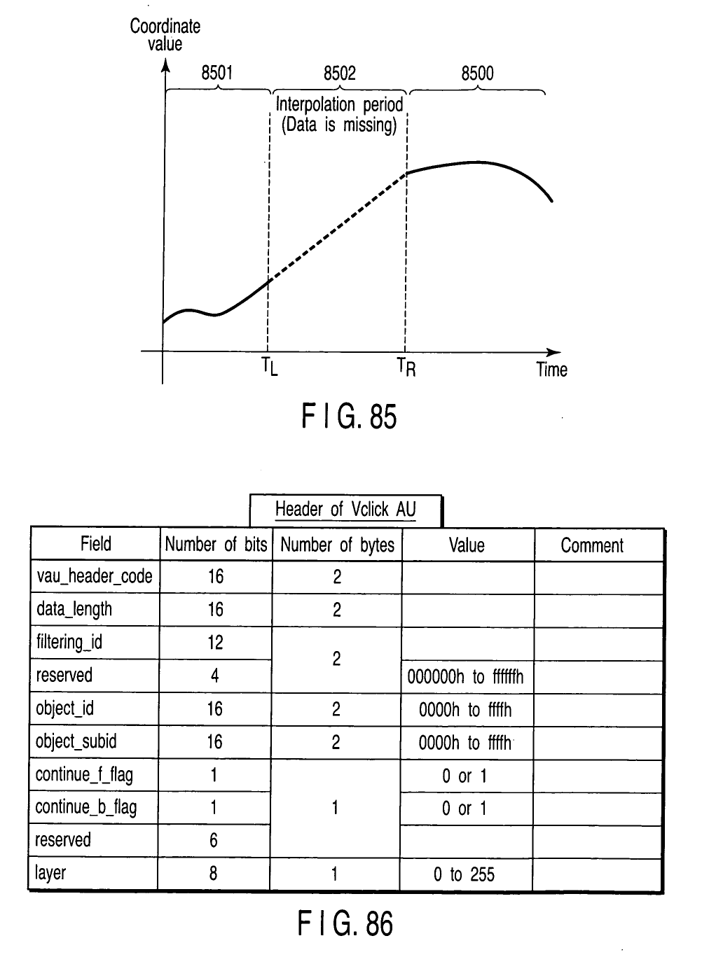

FIG. 85 is an explanatory view of an interpolation processing performed in step S8406. Here, it is assumed that an object region in each frame is approximately expressed in polygons or ellipses as the object region data 400 (for example, spatio-temporal locator of MPEG-7). In FIG. 85, the abscissa axis denotes time, and the ordinate axis denotes X (or Y) coordinate value of a certain vertex of a polygon which expresses the object region. A locus of the coordinate value in a range 8500 after the time T_{R} is described in the Vclick AU which is currently being processed, and a locus of a coordinate value in a range 8501 before the time T_{L} is described in the previous Vclick AU. It is determined in the processing up to step S8403 that the Vclick AU where a locus of the coordinate value in a range 8502 from the time T_{L} to T_{R} is described is missing.

At this time, in the interpolation processing in step S8404, the coordinate values at the time T_{L} and the time T_{R} are linearly interpolated to generate the coordinate values in the missing range from the time T_{L} to T_{R}. Since a polygon has several vertexes, a similar processing is performed for X coordinates and Y coordinates of the respective vertexes, and an object region in the range from the time T_{L} to T_{R} which is finally missing is generated.

The continue flag is defined as a flag which indicates whether or not the object region described in the Vclick AU is temporally continuous to the object region described in the next Vclick AU having the same object_id. However, even when it is defined as a flag which indicates temporal continuity with the object region described not in the next Vclick AU but in the previous Vclick AU, the similar interpolation processing can be performed.

In the above processing, when an intermediate Vclick AU is missing among several Vclick AUs where temporally continuous objects regions are described, a determination of absence is correctly made. When the header Vclick AU is missing, the interpolation processing cannot be performed. When the last Vclick AU is missing, there is a possibility that even a time period where an object is not present may be interpolated when a temporally discontinuous object region appears later. The simplest method of avoiding such erroneous interpolation is to set an upper limit for the time interval when the interpolation processing is performed and not to perform the interpolation over a longer time than the upper limit. Another method is to use not only one continue flag but also a Vclick AU header including two flags, such as a continue f flag and continue b flag, which indicate the continuity between the previous and next Vclick AUs.

The continue b flag indicates whether or not the object region described in this Vclick AU is temporally continuous to the object region described in the next Vclick AU having the same object_id. When the regions are continuous, the flag is “1”, and otherwise, the flag is “0”. On the other hand, the continue f flag indicates whether or not the object region described in this Vclick AU is temporally continuous to the object region described in the previous Vclick AU having the same object_id. When the regions are continuous, the flag is “1”, and otherwise, the flag is “0”.

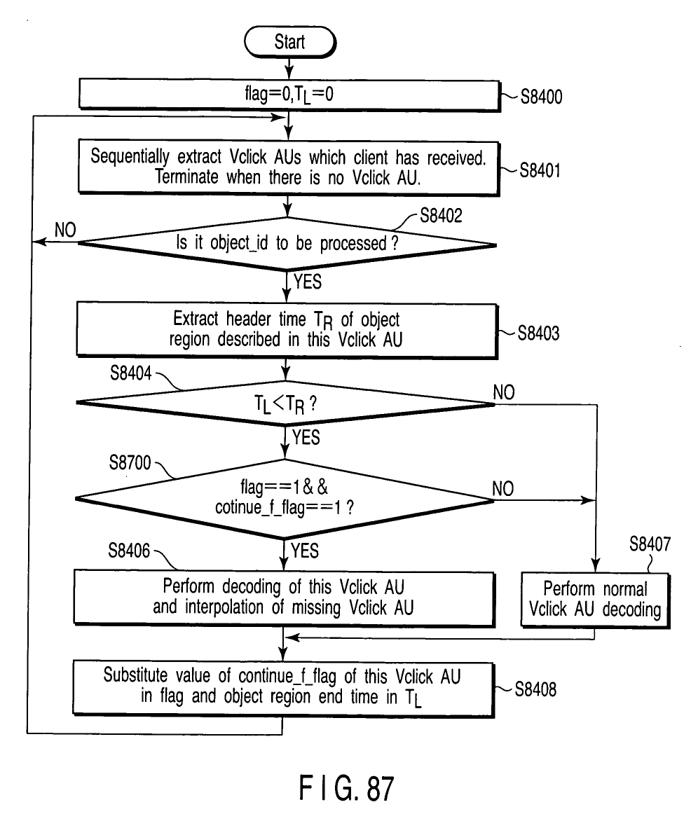

FIG. 87 is a flow chart for explaining a processing example of using the continue f flag and the continue b flag to interpolate a missing Vclick AU. It is different from FIG. 84 in that step S8405 is replaced with step S8700. In step S8700, a determination is made as to whether or not the interpolation processing is performed in consideration of the value of the continue f flag which indicates the continuity with the object region described in the past Vclick AU.

(Compression of Text)

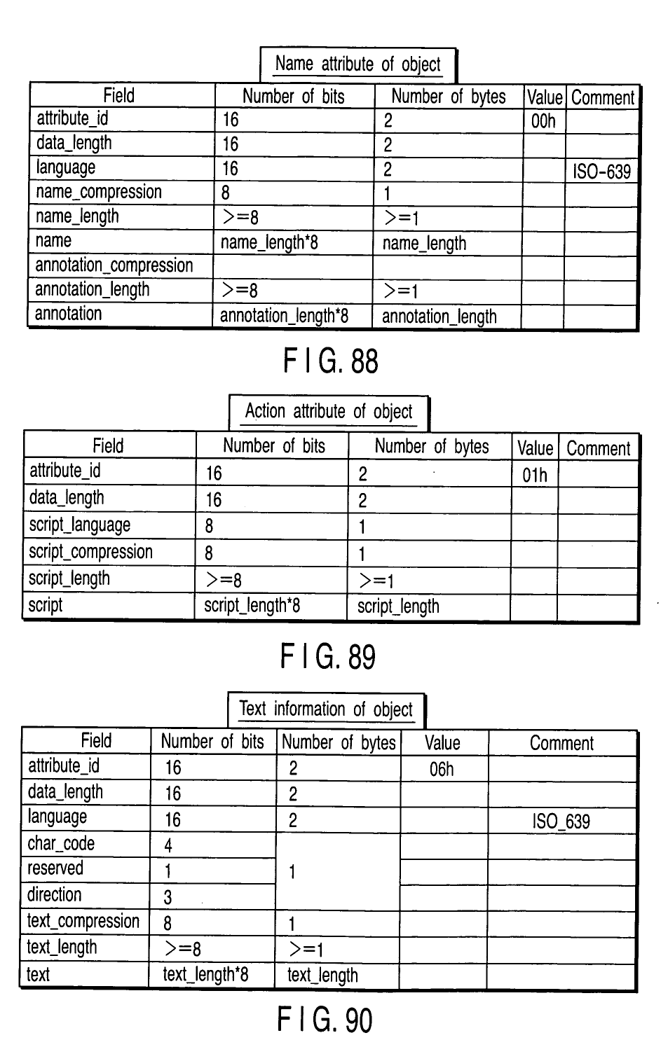

Any text data is included in the data of the Vclick AU explained above. Converting text into data as character codes is inefficient for large numbers of data. When there is much text to be described, it is better to compress only text data and to store the same in the Vclick AU. FIGS. 88, 89, and 90 are data structure examples of a name attribute of an abject which can compress text data, an action attribute of an object, and text information of an object, respectively.

In the data structure of the name attribute of an object in FIG. 88, name compression data is present in addition to the data structure in FIG. 19. The data specifies whether the name data of the succeeding object is compressed or non-compressed, and specifies the compression method when the data is compressed. When the data is compressed, name length indicates the data size of the compressed data, and the compressed text data is stored in name. Similarly also in annotation, annotation compression specifies whether annotation data is compressed or non-compressed, and specifies the compression method when the data is compressed. Annotation length specifies the data size of annotation.

The data structure of the action attribute of an object in FIG. 89 is added with script compression data as compared with the data structure in FIG. 20. Script compression specifies whether script data is compressed or non-compressed, and specifies the compression method when the data is compressed. Script length specifies the data size of script.

The data structure of the text information of an object in FIG. 90 is constituted by adding text compression data to the data structure in FIG. 25. Text compression specifies whether text data is compressed or non-compressed, and specifies the compression method when the data is compressed. Text length specifies the data size of script.

What is claimed is:

1. A data structure of a meta data stream which is configured to include two or more access units which are data units capable of being independently processed, the access unit having first data where a spatio-temporal region of an object in a moving picture is described and second data which specifies whether or not objects in a moving picture, which are respectively designated by the object region data in at least two different access units, are semantically identical.

2. A method of searching the object by using the meta data stream according to claim 1, comprising:
extracting from the meta data stream a plurality of access units determined to be the same objects by the second data;
selecting one of the plurality of extracted access units; and
using the selected access unit to perform the search.

3. The data structure of a meta data stream according to claim 1, wherein each of the access units further has third data which specifies, when objects in a moving picture, which are respectively designated by the object region data in said at least two access units, are semantically identical, whether or not the object region data in said at least two access units is data on the same scene in the moving picture.

4. A method of searching the object by using the meta data stream according to claim 3, comprising:
extracting from the meta data stream a plurality of access units which are determined to be the same objects by the second data and are determined to be the same scene by the third data;
selecting one of the plurality of extracted access units; and
using the selected access unit to perform the search.

5. The data structure of a meta data stream according to claim 1, wherein each of the access units, including first and second access units, further has fourth data which specifies whether or not the second access unit is included in the meta data stream, the second access unit having said first data which is continuous to the object region data in the first access unit on a time axis of the moving picture, the first data being specified to designate the semantically same object by the third data in the first access unit.

6. A method of playing back the meta data stream according to claim 5, comprising:
using the second data and the fourth data in the first access unit to determine whether the second access unit misses either before or after the first access unit; and
when the second access unit misses, interpolating a spatio-temporal region of an object specified by the first data in the second access unit from the first access unit and the third access unit before and after the second access unit.

7. A data structure of a meta data stream which is configured to include one or more access units which are data units capable of being independently processed, the access unit having:
first data where a spatio-temporal region of an object in a moving picture is described;
second data which specifies whether or not objects in a moving picture, which are respectively designated by the object region data in at least two access units, are semantically identical;
text data; and
third data which indicates whether the text data is compressed or non-compressed.

8. A data structure of a meta data stream which is configured to include one or more access units which are data units capable of being independently processed, the access unit having:
first data which specifies a lifetime defined for a time axis of a moving picture;
second data including at least one of data which specifies object region data where a spatio-temporal region of an object in the moving picture is described and a display method associated with the spatio-temporal region, and data which specifies a processing performed when the spatio-temporal region is designated;
text data; and
third data which indicates whether the text data is compressed or non-compressed.

9. An information medium configured to adapt the data structure of claim 1, 7, or 8.

10. An apparatus comprising a data processing engine configured to handle the data structure of claim 1, 7, or 8.
